(19) United States
(12) Patent Application Publication
(10) Pub. No.: US 2014/0037828 A1
(43) Pub. Date: Feb. 6, 2014

(54) FOOD COOKING APPARATUS AND METHOD

(71) Applicant: Leszek Kot, Middletown, CT (US)

(72) Inventor: Leszek Kot, Middletown, CT (US)

(21) Appl. No.: 13/967,714

(22) Filed: Aug. 15, 2013

Related U.S. Application Data
(63) Continuation-in-part of application No. 13/850,907, filed on Mar. 26, 2013.
Application No. 13/850,907 is a continuation-in-part of application No. 13/757,750, filed on Feb. 2, 2013.
(60) Provisional application No. 61/594,511, filed on Feb. 3, 2012.

(51) Int. Cl. A47J 37/04; A23L 1/216

(52) U.S. Cl. CPC A47J 37/045; A23L 1/2161
USPC 426/637; 99/443 C; 99/342; 426/523

(57) ABSTRACT

A food product comprising: a potato mixture that is cooked without frying; where the food product has the appearance, taste and texture similar to a French fry cooked in oil; and where the food product has less than 20 calories per cubic inch. A food cooking apparatus comprising: a bottom continuous belt comprising a plurality of bottom channels; a top continuous belt, that meshes with the bottom continuous belt; and where the food cooking apparatus is configured to rotate the top continuous belt and bottom continuous belt such that any food desposited onto the bottom channels is suitably cooked when it leaves the bottom continuous belt and enters the finished food holding container.

### CROSS-REFERENCES

This patent application is a continuation-in-part of patent application Ser. No. 13/850,907, by Leszek Kot, entitled “Food Cooking Apparatus and Method”, filed on Mar. 26, 2013, the entire contents of which are fully incorporated by reference herein. Patent application Ser. No. 13/850,907 is a continuation-in-part of patent application Ser. No. 13/757,750, by Leszek Kot, entitled “Food Cooking Apparatus and Method”, filed on Feb. 2, 2013, the entire contents of which are fully incorporated by reference herein. Patent application Ser. No. 13/757,750 claims the benefit of provisional patent application No. 61/594,511, by Leszek Kot, entitled “Method and Apparatus for Making a Potato Product”, filed on Feb. 3, 2012, and which provisional application is fully incorporated by reference herein.

### TECHNICAL FIELD

The invention relates to a food cooking apparatus and method, and, more particularly, to food cooking apparatus and method that can cook a relatively low calorie food with a generally crispy surface.

### BACKGROUND

In today's hectic and fast pace life, people do not have time or simply do not pay enough attention to how many calories they consume each and every day. Because of over consumption of food and not enough exercise, obesity is becoming a major problem throughout the USA and the world. French fries are one of the most popular lunch/dinner side snacks that are consumed by millions each day. A standard large order of French fries contains about 500 calories of which about 220 are calories from fat.

Right now there is no solution to this high calorie snack that is enjoyed by millions every day. Many organizations and individuals are encouraging healthy eating and exercise but until the food is replaced with something better and healthier, the obesity problem will not go away. Consumers are encouraged to either substitute the French fries with a salad or other healthier choice. Without this invention, French fries will continue to be made the same way and consumers will continue to buy it.

Currently there is no known device that can produce a food product that when fully cooked, has generally the texture, taste and crispiness of a French fry. Known devices include conveyor type ovens with heaters that heat the top and bottom of conveyors but they do not provide a crispy texture to the food.

There are known Panini presses that open up and allow one to place a food item such as a sandwich inside the Panini press, and close the press in order to heat the sandwich or some other foods. A problem with the Panini press is that grill plates have uneven grooves that may work well for grilling a sandwich, but are not suitable for making a food that tastes and looks like a French fry.

Thus there is a need for a food cooking apparatus and method that overcomes the above listed and other disadvantages.

### SUMMARY OF THE INVENTION

The invention relates to a food product comprising: a potato mixture that is cooked without frying; where the food product has the appearance, taste and texture similar to a French fry cooked in oil; and where the food product has less than 20 calories per cubic inch.

The invention also relates to a food cooking apparatus comprising: a housing; a holding tank attached to the housing; an extruder in fluid communication with the holding tank; a bottom continuous belt generally adjacent to the extruder, the bottom continuous belt comprising a plurality of bottom channels on the outer surface of the belt; a top continuous belt, that meshes with the bottom continuous belt along a belt mesh length, the top continuous belt comprising a generally flat surface on the outer surface of the belt such that at the belt mesh length, the generally flat surface and each bottom channel form a cooking volume, where the cooking volume has a cooking surface that is configured to generally completely abut the outer surface of a food located in the cooking volume; a bottom heater attached to the housing and configured to heat the bottom continuous belt at the belt mesh length in order to cook the food within the cooking volume; a top heater attached to the housing and configured to heat the top continuous belt at the belt mesh length in order to cook the food within the cooking volume; a food holding container attached to the housing, and adjacent to the end of the bottom continuous belt opposite the extruder end of the belt; and where the food cooking apparatus is configured to rotate the top continuous belt and bottom continuous belt such that any food deposited from the extruder onto the bottom channels tend to move towards the belt mesh length and into the cooking volume then out into the finished food holding container, and that the top and bottom heaters heat the belt mesh length and the food remains in the cooking volume for such time that the food is suitably cooked when it leaves the bottom continuous belt and enters the finished food holding container.

In addition, the invention relates to a food cooking apparatus comprising: a housing; a holding tank attached to the housing; an extruder in fluid communication with the holding tank; a bottom continuous belt generally adjacent to the extruder, the bottom continuous belt comprising a plurality of bottom channels on the outer surface of the belt; at least one pair of bottom endwalls located in at least one bottom channel, the pair of bottom endwalls creating at least one discrete bottom cooking volume in the channel; a top continuous belt, that meshes with the bottom continuous belt along a belt mesh length, the top continuous belt comprising a plurality of top channels on the outer surface of the belt; at least one pair of top endwalls located in at least one top channel, the pair of top endwalls creating at least one discrete top cooking volume in the channel; a belt mesh length, formed by the meshing of the bottom and top continuous belt, such that each pair of adjacent top and bottom channels form a cooking volume, and where each discrete bottom cooking volume and discrete top cooking volume mesh together to form a generally closed cooking volume, where the cooking volume has a cooking surface that is configured to generally completely abut the outer surface of a food located in the cooking volume; a bottom heater attached to the housing and configured to heat the bottom continuous belt at the belt mesh length in order to cook the food within the cooking volume; a top heater attached to the housing and configured to heat the top continuous belt at the belt mesh length in order to cook the food within the cooking volume; a food holding container attached to the housing, and adjacent to the end of the bottom continuous belt opposite the extruder end of the belt; and where the food cooking apparatus is configured to rotate the top continuous belt and bottom continuous belt such that any food deposited from the extruder onto the bottom channels tend to move towards the belt mesh length and into the cooking volume then out into the finished food holding container, and that the top and bottom heaters heat the belt mesh length and the food remains in the cooking volume for such time that the food is suitably cooked when it leaves the bottom continuous belt and enters the finished food holding container.

Additionally, the invention relates to a method of cooking food, the method comprising: preparing a potato paste mix; placing a length of the mix into respective bottom channels of a cooking surface; enclosing the length of mix in a cooking volume, such that an outer surface of the length of mix is generally entirely abutting a cooking surface formed by the cooking volume; cooking the length of mix with the cooking surface generally touching the entire outer surface of the length of mix; removing the cooked lengths of mix from the cooking surface; freezing the cooked lengths of mix; delivering the cooked lengths of mix to retail stores or end users; reheating the cooked lengths of mix; serving the cooked lengths of mix.

Furthermore, the invention relates to a method of cooking food, the method comprising: preparing a potato paste mix; refrigerating or freezing the potato paste mix; delivering the potato paste mix to retail stores or end users; placing a length of the mix into respective bottom channels of a cooking surface; enclosing the length of mix in a cooking volume, such that an outer surface of the length of mix is generally entirely abutting a cooking surface formed by the cooking volume; cooking the length of mix with the cooking surface generally touching the entire outer surface of the length of mix; removing the cooked lengths of mix from the cooking surface; serving the cooked lengths of mix.

The invention, also relates to a vending machine style food cooking apparatus comprising: a housing; a holding tank attached to the housing; an extruder in fluid communication with the holding tank; a bottom continuous belt generally adjacent to the extruder, the bottom continuous belt comprising a plurality of bottom channels on the outer surface of the belt; a top continuous belt, that meshes with the bottom continuous belt along a belt mesh length, the top continuous belt comprising a plurality of top channels on the outer surface of the belt such that at the belt mesh length, each pair of adjacent top and bottom channels form a cooking volume, where the cooking volume has a cooking surface that is configured to generally completely abut the outer surface of a food located in the cooking volume; a bottom heater attached to the housing and configured to heat the bottom continuous belt at the belt mesh length in order to cook the food within the cooking volume; a top heater attached to the housing and configured to heat the top continuous belt at the belt mesh length in order to cook the food within the cooking volume; a food holding container attached to the housing, and adjacent to the end of the bottom continuous belt opposite the extruder end of the belt; an electronic display located on the housing; a payment accepting mechanism located on the housing; a CPU located within the housing and in signal communication with electronic display and payment accepting mechanism; where the food cooking apparatus is configured, upon proper payment made at the payment accepting mechanism, to rotate the top continuous belt and bottom continuous belt such that any food deposited from the extruder onto the bottom channels tend to move towards the belt mesh length and into the cooking volume then out into the finished food holding container, and that the top and bottom heaters heat the belt mesh length and the food remains in the cooking volume for such time that the food is suitably cooked when it leaves the bottom continuous belt and enters the finished food holding container.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a perspective view of a first embodiment of the food cooking apparatus;

FIG. 2 is a top view of the food cooking apparatus from FIG. 1 with enclosure removed;

FIG. 3 is a front view of the food cooking apparatus from FIG. 1 with enclosure removed;

FIG. 4 is a perspective view of the bottom belt;

FIG. 5 is a perspective view of the top belt;

FIG. 6 is a top view of one segment of a belt;

FIG. 7 is a side view of one segment of a belt;

FIG. 8 is a cross-sectional view of one segment of a belt;

FIG. 9 is a front view of a holding tank;

FIG. 10 is a side view of the holding tank from FIG. 9:

FIG. 11 is front view of a second embodiment of the food cooking apparatus;

FIG. 12 is a side view of the food cooking apparatus from FIG. 11;

FIG. 13 is a front view of a third embodiment of the food cooking apparatus;

FIG. 14 is a partial cut-away view of the food cooking apparatus from FIG. 13;

FIG. 15 is perspective view of a holding tank;

FIG. 16 is a perspective view of the interior of the holding tank;

FIG. 17 is a perspective view of the extruder;

FIG. 18 is a perspective view of the cutting mechanism;

FIG. 19 is a view of the drive system of the food cooking apparatus;

FIG. 20 is a view of the power and control system of the food cooking apparatus;

FIG. 21 is a rear view of the drive system of the food cooking apparatus;

FIG. 22 is a detail view of the exit shoot;

FIG. 23 is a detail view of the extrusion holes;

FIG. 24 is a view of the belt frames;

FIG. 25 is a bottom view of the bottom belt frame;

FIG. 26 is a detail view of the cooking surfaces of the top and bottom belts;

FIG. 27 is a perspective view of two segments of the bottom belt;

FIG. 28 is a perspective view of two segments of the top belt;

FIG. 29 is a side view of the meshed segments from the top and bottom belts;

FIG. 30 is view of a fourth embodiment of the disclosed food cooking apparatus;

FIG. 31 is a side view of the plates from FIG. 30;

FIG. 32 is a perspective view of the plates from FIG. 30 in an opened configuration;

FIG. 33 is a flowchart illustrating one method of the invention;

FIG. 34 is a flowchart illustrating another method of the invention;

FIG. 35 shows a view of the mechanisms inside the holding tank;

FIG. 36 is a detailed view of the horizontal pusher assembly;

FIG. 37 is a detailed view of the vertical pusher assembly;

FIG. 38 is a detailed view of the vertical cutter assembly;

FIG. 39 is a detailed view of the removable mix holding container;

FIG. 40 is a bottom view of the removable mix holding container;

FIG. 41 is a close-up view of a frozen stick embodiment of the food cooking apparatus;

FIG. 42 is a close up view of the angled slider;

FIG. 43 is a view of the holding tank with one wall removed;

FIG. 44 is a side view of the food cooking apparatus from FIG. 41, with the walls of the holding tank removed;

FIG. 45 is a close up view of the pedestal;

FIG. 46 is a close-up view of the push mechanism;

FIG. 47 is a detailed view of the pedestal channels;

FIG. 48 is a calorie chart;

FIG. 49 shows another embodiment of the bottom belt segments;

FIG. 50 shows another embodiment of the bottom belt segments;

FIG. 51 shows another embodiment of the top belt and bottom belt;

FIG. 52 shows another embodiment of the disclosed method;

FIG. 53 shows another embodiment of the disclosed method;

FIG. 54 is a front view of a disclosed vending machine version of the disclosed food cooking apparatus; and

FIG. 55 is a rear view of the apparatus from FIG. 54.

### DETAILED DESCRIPTION

The food produced through this invention, has generally a similar texture, taste and crispiness to fried French fries with one major difference. This invention significantly reduces the total calories and calories from fat. Using the disclosed invention may result in a lower number of calories consumed daily by millions of consumers. This invention will help in the fight against obesity.

Applicant has invented a new potato food product, also known as “MASH STIX”, which looks and tastes like a French fry, except MASH STIX is healthier due to a different process of making and cooking A potato paste mix with added spices is prepared. The paste is then extruded through a machine, and cut into predetermined lengths, before being grilled to look like French fries. One embodiment of the invention is an automated machine which may be used at restaurants, fast food establishments, campus dining halls, cafeterias, etc. . . . Generally, the automated machine may be used in any food service arena where there is a relatively high volume outputs required. Another embodiment of the invention is a manually fed machine for household use where the volume output is lower.

A potato paste mix with added spices may be prepared. In one embodiment, the potato paste mix may be made by boiling potatoes, draining the excess water, mashing the potatoes and adding spices. If prepared off-site, the mix may be packaged and delivered to establishments that have the automated machine. The mix can also be prepared and pre-formed off-site for the household embodiment. The potato paste mix may also be flavored and colored during the mixing process which may result in a flavored and colored food product that has the coloring and flavoring throughout the entire final food product.

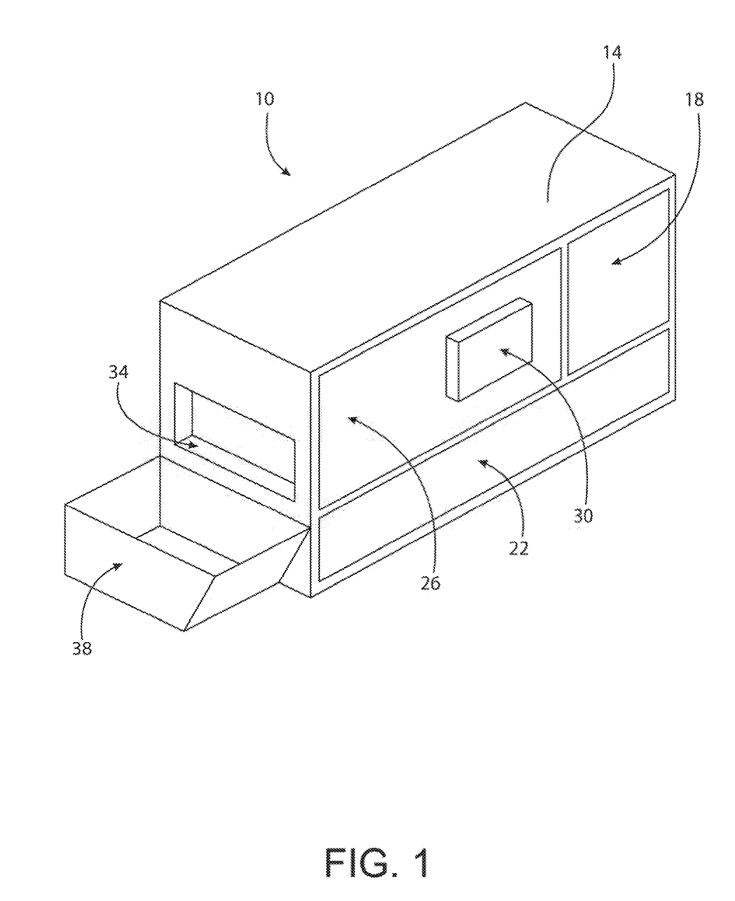

Referring to FIG. 1, one embodiment of the food cooking apparatus 10 is shown in a perspective view. The food cooking apparatus 10 comprises a housing 14. The housing 14 may have a first access panel 18, a second access panel 22, and a third access panel 26. The housing 14 may also have an electronic panel 30. The housing 14 has an exit slide 34 where the cooked food can slide out from inside the housing 14 into a finished food holding container 38.

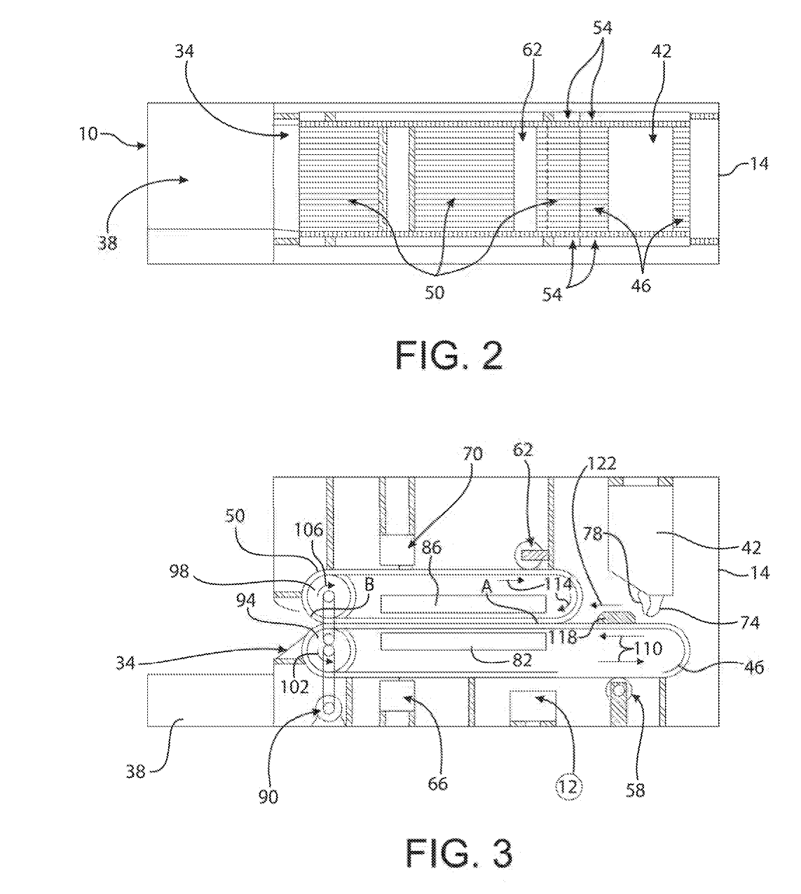

FIG. 2 shows a top view of the food cooking apparatus 10 with the top portion of the housing 14 removed. A holding tank 42 is shown above a bottom belt 46. A top belt 50 is shown generally above the bottom belt 46. The food cooking apparatus may have optional guide rails 54 that guide the bottom and top belts 46, 50. A bottom belt greater 58 and top belt greater 62 apply a thin layer of a suitable oil (e.g., a canola oil) onto the surfaces of the belts 46, 50 that the potato mix will come in contact with to prevent burning and/or sticking of the potato mix to the belt surfaces. A bottom belt cleaner 66 wipes off any excess oil and other accumulations from the belt surface. A top belt cleaner 70 wipes off any excess oil and other accumulations from the belt surface. Attached to the holding tank 42 is an extruder nozzle 74. In another embodiment, the extruder nozzle 74 may be a simple feeding means, that is a device that feeds the mix from the holding tank 198 to the channels 130. A cutter 78 is located between the extruder nozzle 74 and the bottom belt 46, and cuts the food that exits the extruder nozzle. In one embodiment, the cutter 78 is configured to cut the food into generally French fry length pieces. A bottom belt heater 82 and top belt heater 86 heats the bottom and top belt 46, 50 respectively. A driver motor 90 is in operable communication with a bottom belt gear 94 and top belt gear 98, and causes the bottom belt gear 94 to rotate in an opposite direction to the top belt gear 98 as shown by the arrows 102, 106. The bottom belt gear 94 causes the bottom belt 46 to move in the direction of the arrows 110; and the top belt gear 98 causes the top belt 50 to move generally in the direction of the arrows 114.

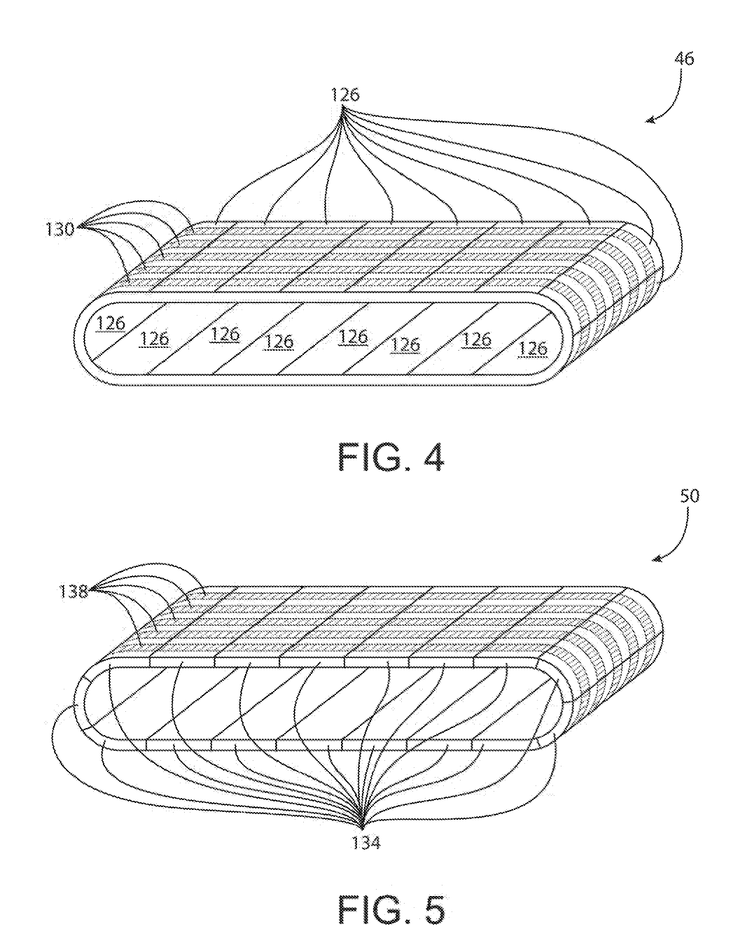

When in operation, the bottom belt moves in generally the direction shown by the bottom belt arrows 110, and the top belt moves in generally the direction shown by the top belt arrows 114. The food product 118 exits the extruder nozzle 74 and is cut into suitable lengths by the cutter 78. The extruder nozzle 74 is configured to place the food product 118 in a bottom belt channel 130 (see FIG. 4). Once placed in the bottom belt channel 130, the food product 118 moves generally in the direction of the arrow 122.

FIG. 4 is a simplified drawing of a bottom belt. The bottom belt 46 is generally a continuous belt comprising a plurality of segments 126 that are transverse to the continuous direction of the belt. Each segment can rotate with respect to an adjacent segment. The outer surface of the belt 46 comprises a plurality of channels 130 that are generally continuous along the continuous direction of the belt. In one embodiment, the bottom belt 46 is made generally out of a metallic material, with a non-stick surface on the belt's outer surface. Because the bottom belt 46 is made generally out of a metallic material, the segments allow the belt to smoothly wrap and rotate about the bottom belt gear 94. FIG. 5 is a simplified drawing of a top belt 50. The top belt 50 is generally a continuous belt comprising a plurality of segments 134 that are transverse to the continuous direction of the belt. Each segment can rotate with respect to an adjacent segment. The outer surface of the belt 50 comprises a plurality of channels 138 that are generally continuous along the continuous direction of the belt. In one embodiment, the top belt 50 is made generally out of a metallic material, with a non-stick surface on the belt's outer surface. Because the top belt 50 is made generally out of a metallic material, the segments allow the belt to smoothly wrap and rotate about the top belt gear 98.

Referring now to FIG. 3, as the food product 118 travels to in the direction of the arrow 122, the bottom belt 46 and top belt 50 meet. However, each pair of channels 130, 138 form generally a single cooking volume in the area where the bottom belt 46 and top belt 50 abut each other, i.e. one bottom channel 130 and one adjacent top channel 138 form a single cooking volume. Thus the food product 118, as it lies in the cooking volume, abuts the cooking surface formed by the top and bottom belt channels 130, 138. Because the food product 118 abuts the cooking surface generally about its entire outer surface (except for the small portion at the front end and rear end of the food product 118), the outer surface of the food product develops a crispy French fry-like texture. The food product 118 is in generally total contact with the cooking surface from point A to point B, where at point B the food product exits the belts 46, 50 and slides down the exit slide 34 to the finished food holding container 38. The area of the belts between point A and point B shall be called the belt mesh length. The shape of the bottom and top belt 46, 50 as viewed from the angle shown in FIG. 3, may be described as an ellipse, although more accurately it comprises generally two semicircles separated by two parallel lines. The cooking volume is not limited only to circular shape cross-section; any other suitable shape may be used, including square, oval, rectangular, triangular, etc.

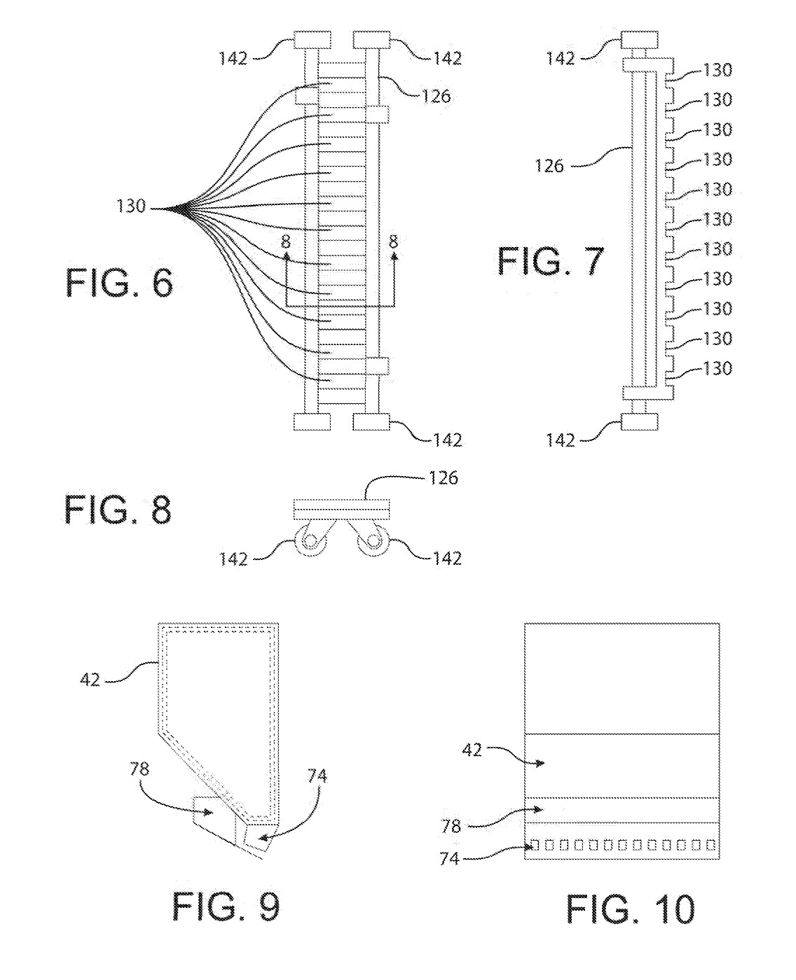

FIG. 6 is a detail view of one bottom belt segment 126, with the cooking surface and bottom belt channels 130 facing the viewer. The segment 126 may have bearings 142 that allow the bottom belt segment 126 to smoothly ride in the guide rails 54.

FIG. 7 is a side view of one bottom belt segment 126.

FIG. 8 is a cross-sectional view of one bottom belt segment 126.

FIG. 9 is a front view of the holding tank 42, extruder nozzle 74, and cutter 78. FIG. 10 is a side view of the holding tank 42, extruder nozzle 74, and cutter 78.

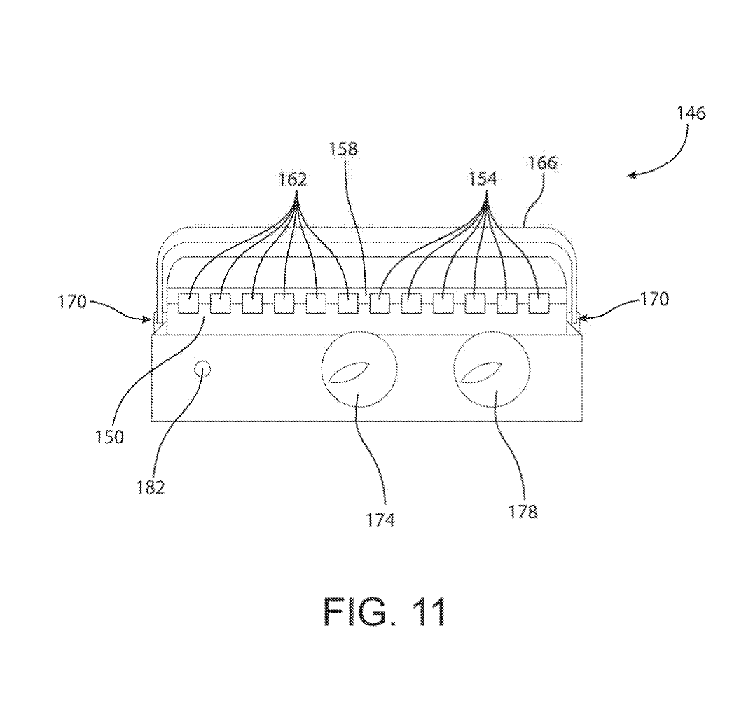

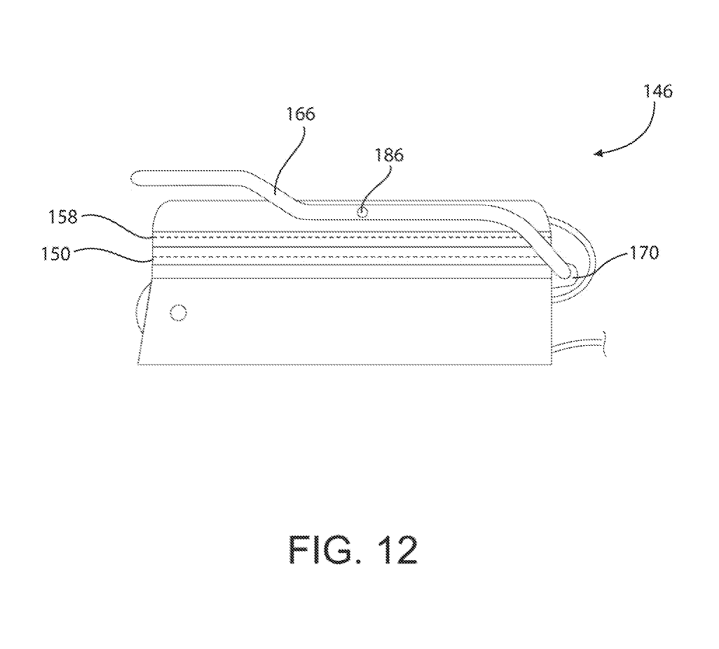

FIG. 11 is a front view of another embodiment of the food cooking apparatus 146. In this embodiment, there is no belt system, but rather there is a fixed plate 150 with bottom channels 154. A rotating plate 158 with top channels 162 is configured to rotate with respect to the fixed plate 150. when the rotating plate 158 is abutted to the fixed plate, each pair of channels 154, 162 form a single cooking volume, i.e. one of the bottom channels 154 and the adjacent top channel 162 forms a single cooking volume. The apparatus 146 may have a handle 166 to lift/rotate the rotating plate 158 about hinges 170. The apparatus 146 may have a control knob 174 to control the temperature of the plates 150, 158, a timer knob 178 to control a timer, and a ready light 182. FIG. 12 is a side view of the food cooking apparatus 146. The handle may be attached to the rotating plate via an attaching means 186.

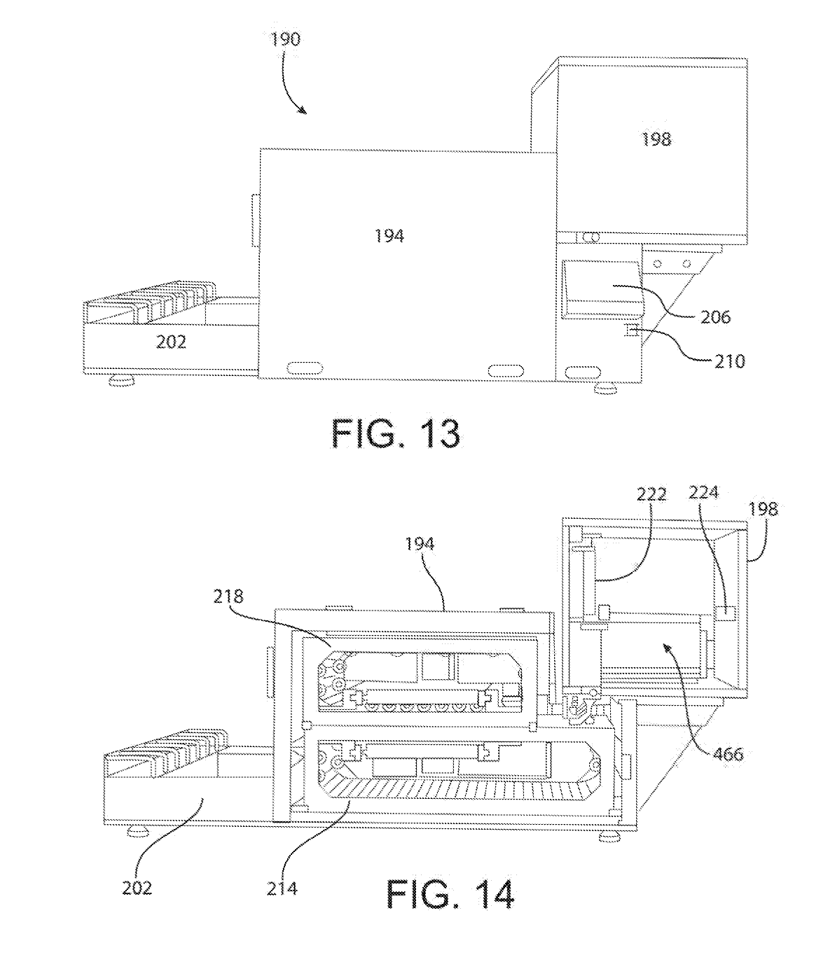

FIG. 13 is a generally side view of another embodiment of the food cooking apparatus 190. The food cooking apparatus comprises a main housing 194, a holding tank 198, a finished food holding container 202, an electronic display panel 206, and an on/off switch 210. FIG. 14 shows a partial cut-away view of the food cooking apparatus 190 from FIG. 13. In this view the bottom belt assembly 214, and top belt assembly 218 can be seen, as well as the vertical pusher assembly 222 and the horizontal pusher assembly 224 in the holding tank 198.

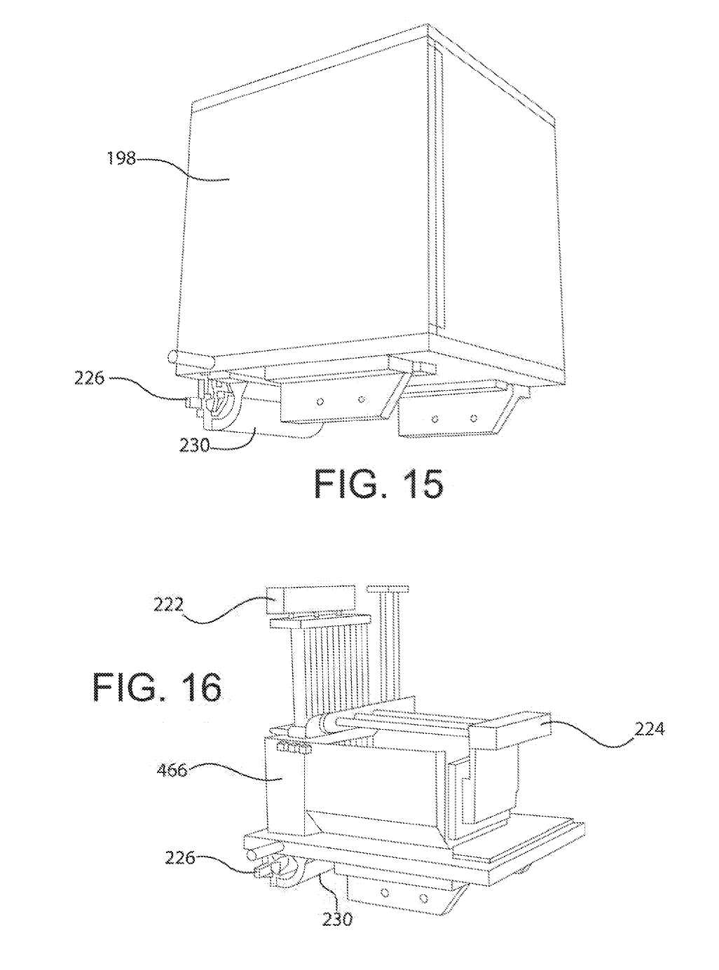

FIG. 15 shows a perspective view of the holding tank. A cutting mechanism 226 is shown attached to the bottom of the holding tank 198, and an extruder 230 is attached to the bottom of the holding tank 198 and adjacent to the cutting mechanism 226.

FIG. 16 shows the mechanism in the interior of the holding tank 198. In this embodiment, there is a vertical pusher assembly 222 and the horizontal pusher assembly 224. These pusher assemblies 222, 224 generally are configured to push a food mix in the holding tank 198 through the extruder 230 and onto a bottom belt.

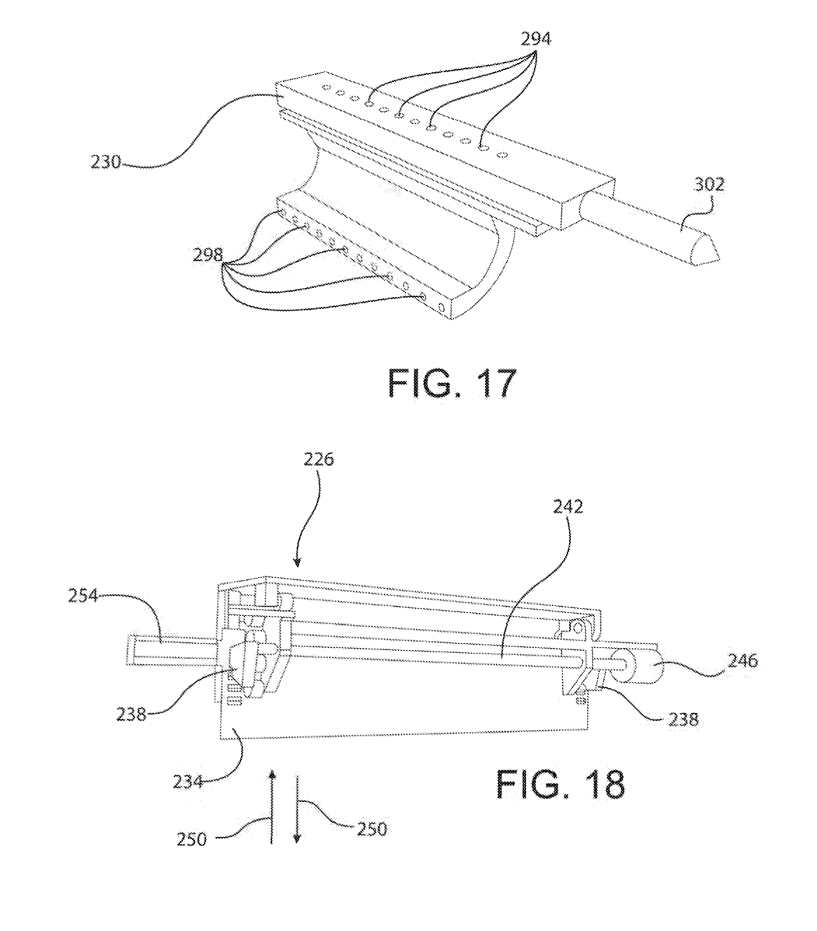

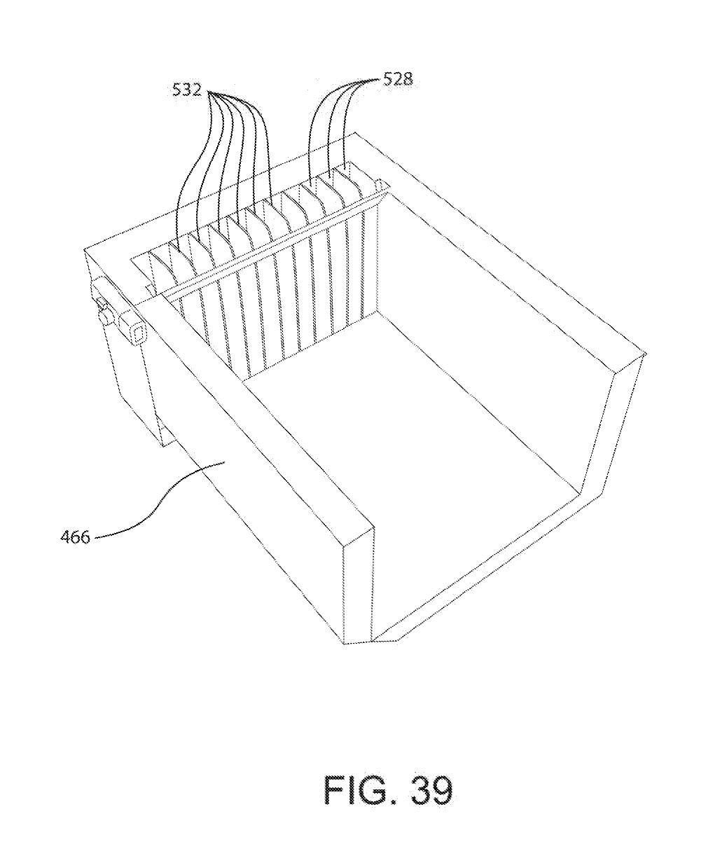

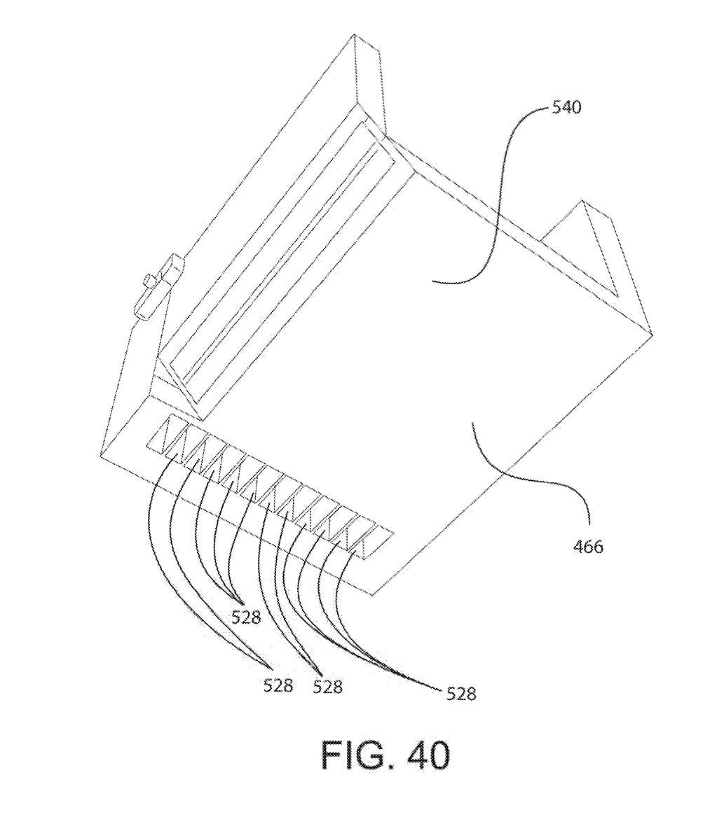

FIG. 17 shows a perspective view of the extruder 230 removed from the food cooking apparatus 190. The extruder 230 has a plurality of entrance holes 294, the number of entrance holes 294 will generally match to the number of channels on the bottom belt. In another embodiment, there may be the same number of equal size segments in the mix holding container which allow for uniform extrusion, see FIGS. 39 to 40. The entrance holes 294, in this embodiment, generally face up. The extruder also has a plurality of exit holes 298. The exit holes 298 and entrance holes 294 are in communication generally through a channel inside the extruder. The number of exit holes also matches the number of channels on the bottom belt. The extruder 230 may have a handle 302, which makes the extruder easier to remove from and re-install on the food cooking apparatus 190. When the extruder is installed on the food cooking apparatus 190, the pusher assemblies 222, 224 are configured to generally force the food mix into the entrance holes 294, and out the exit holes 298 onto the bottom belt channels.

FIG. 18 shows a close up view of the cutting mechanism 226. The cutting mechanism comprises a blade 234, a gear 238 in communication with the blade 234, a drive shaft 242 attached to the gear 238, and a motor 246 in operable communication with the drive shaft 242. When the motor 246 is activated, it turns the drive shaft 242, which in turn turns the gears 238, which causes the blade to move either up or down in the direction of the arrows 246. The blade may have a blade handle 254 for ease of removal, cleaning, and re-installation into the food cooking apparatus 190.

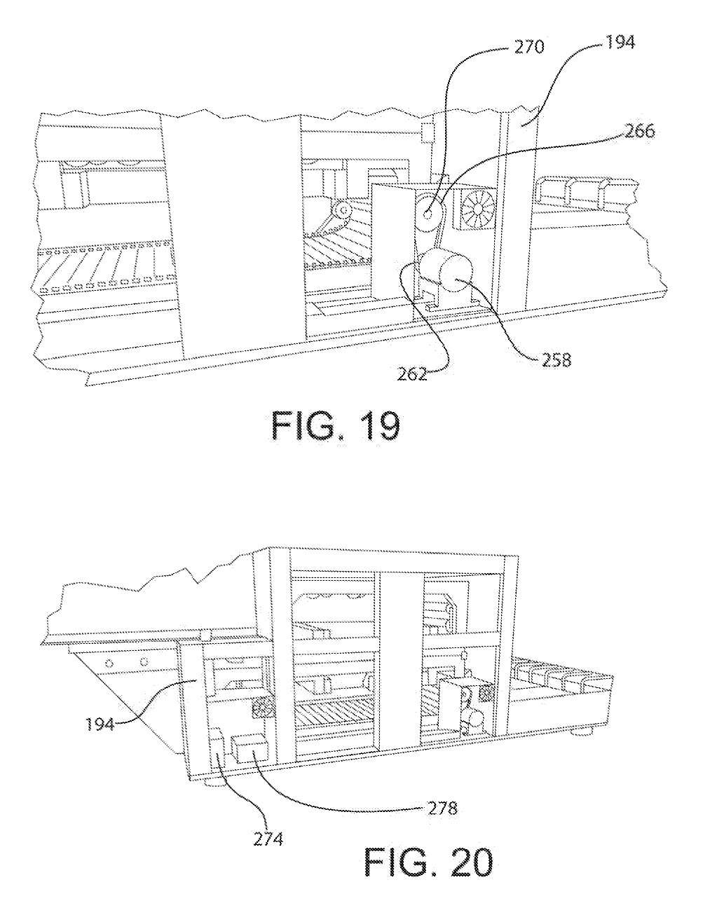

FIG. 19 shows the drive system details for the food cooking apparatus 190. A drive motor 258 located in the main housing 194 drives a belt or chain 262, which turns a gear 266, and which in turn turns a drive shaft 270. FIG. 20 shows details of the power and control system. A power control module 274 and control system module 278 are located in the main housing 194, and control the various motors, vertical and horizontal pushers, the cutting mechanism, electronic control panel, ventilation fans and heaters.

FIG. 21 shows a rear view of the food cooking apparatus 190 with drive system removed. The drive shaft 270 is shown turning two gears 282. The gears 282 mesh with teeth 286 that extend from the inner surface of the bottom belt 290.

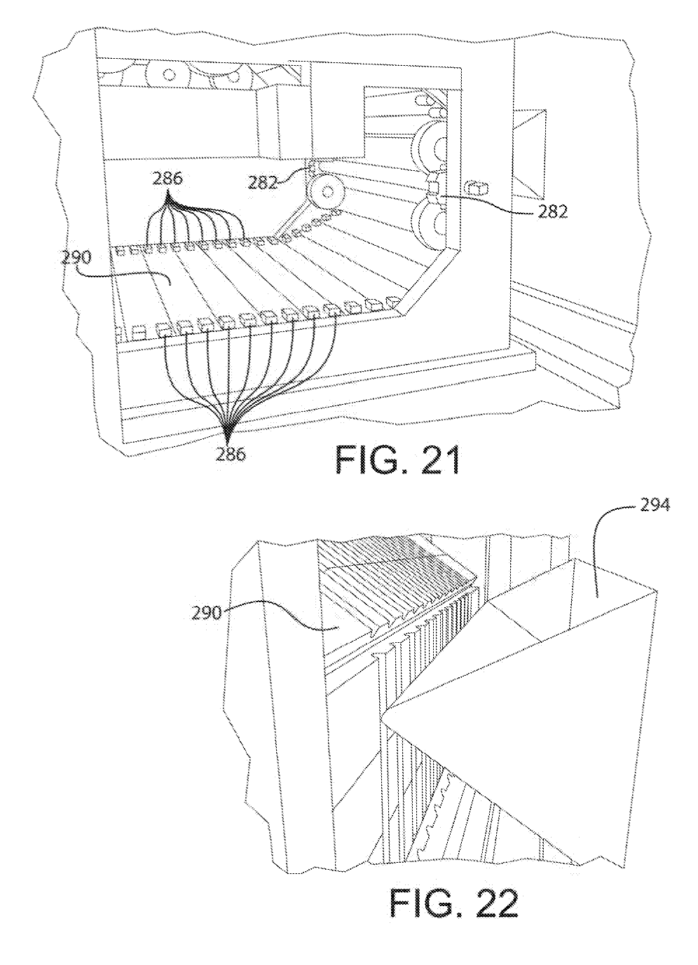

FIG. 22 shows a close up of the bottom belt 290, and an exit shoot 292, where the cooked food product exits the belt 290.

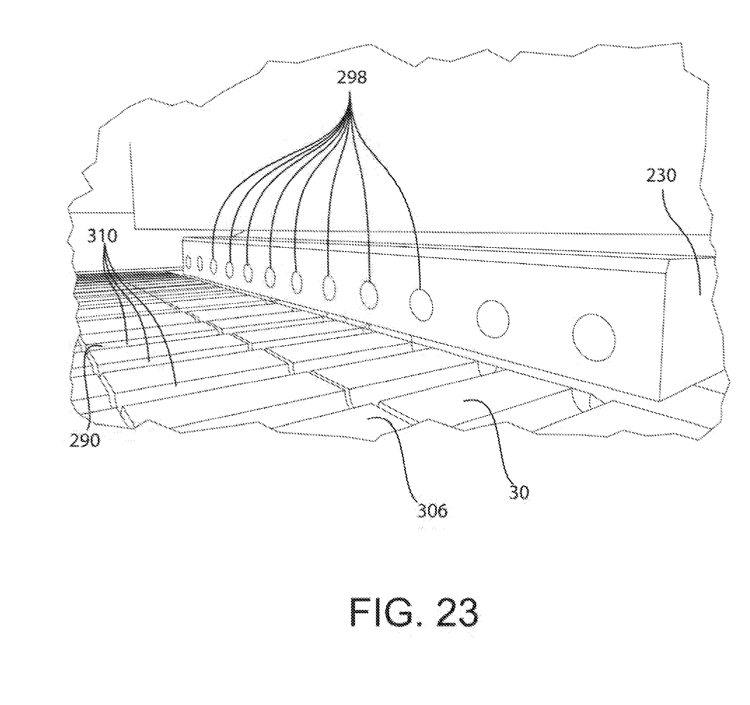

FIG. 23 shows a close-up of the extruder 230 and bottom belt 290. The bottom belt 290 is a continuous belt that comprises a plurality of segments 306. The segments 306 are generally transverse to the continuous direction of the belt. Each segment 306 can rotate with respect to an adjacent segment 306. In one embodiment, the cutting mechanism blade 234 rests right up against the outlet edge of the extruder 230. Along the continuous direction of the belt, are a plurality of channels 310, that run along the entire length of the belt. Each channel 310 is aligned with one of the exit holes 298 of the extruder 230.

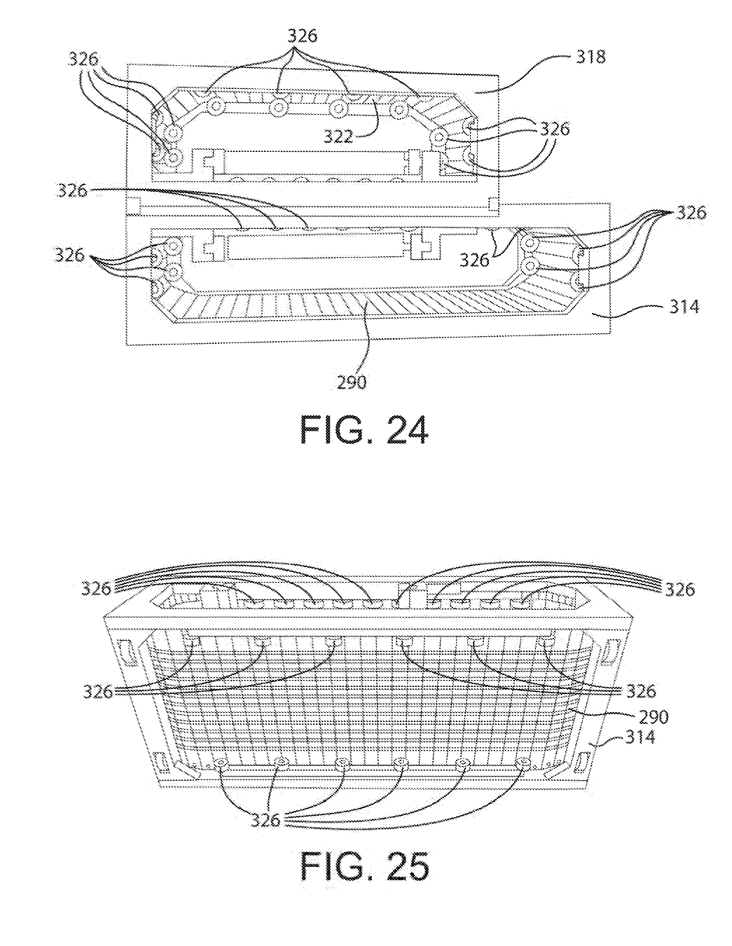

FIG. 24 shows a side view of the bottom belt frame 314 and top belt frame 318. The bottom belt frame 314 houses the bottom belt 290. The top belt frame 318 houses the top belt 322. Guide wheels 326 rotatably attached to the top belt frame 318 generally keep the top belt 322 in place as it rotates within the top belt frame 318. The bottom belt frame 314 also has guide wheels 326 rotatably attached to the frame 314, and generally keep the bottom belt 290 in place as it rotates within the bottom belt frame 314. In addition, there is a bottom heater 330 attached to the bottom belt frame 314 and configured to heat the bottom belt especially when the bottom belt is meshed with the top belt 322. Similarly, a top heater 334 is attached to the top belt frame 318 and heats the top belt 322, especially as it is meshed with the bottom belt 290.

FIG. 25 is a bottom perspective view of the bottom belt frame 314. In this view, one can see the guide wheels at the bottom of the frame 314, which generally keeps the bottom belt 290 in place in the frame 314.

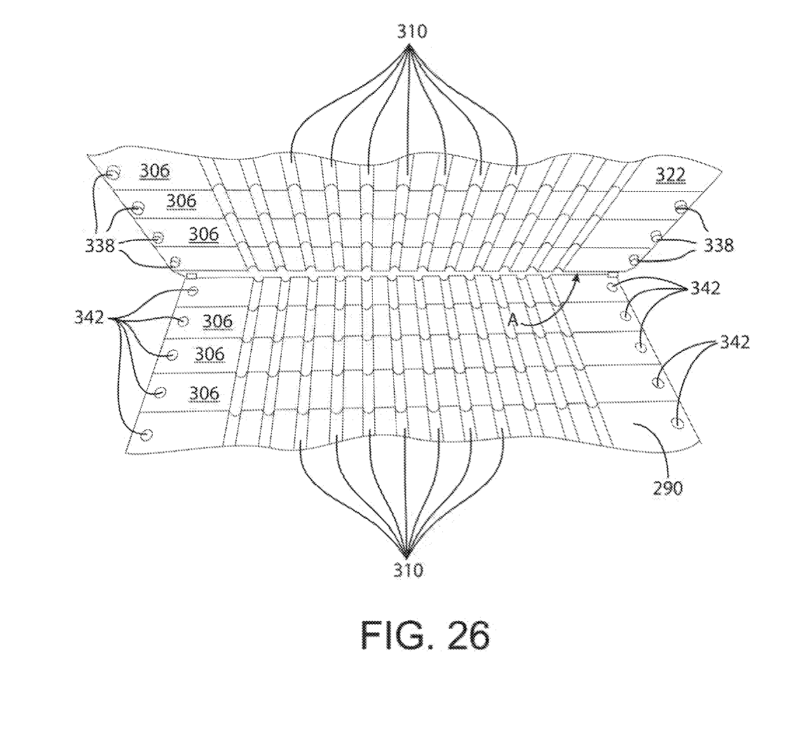

FIG. 26 is a close up view of the cooking surfaces of the bottom belt 290 and the top belt 322. At point A, the bottom belt 290 and top belt 322 abut each other, and the bottom channel 310 and top channel 310 form a single cooking volume. As shown earlier, the bottom belt is rotated by a gear/motor configuration. However, the top belt 322 is rotated directly by the bottom belt 290 due to the drive teeth 338 that extend from the top belt 322 and mesh with the drive receptacles 342 located on the bottom belt 290. Each segment 306 of the bottom belt 290 each has a pair of drive receptacles 342, similarly each segment 306 of the top belt 322 each has two drive teeth 338. One of ordinary skill in the art will recognize that in an alternative embodiment the drive receptacles may be located on the top belt, and the drive teeth may be located on the bottom belt.

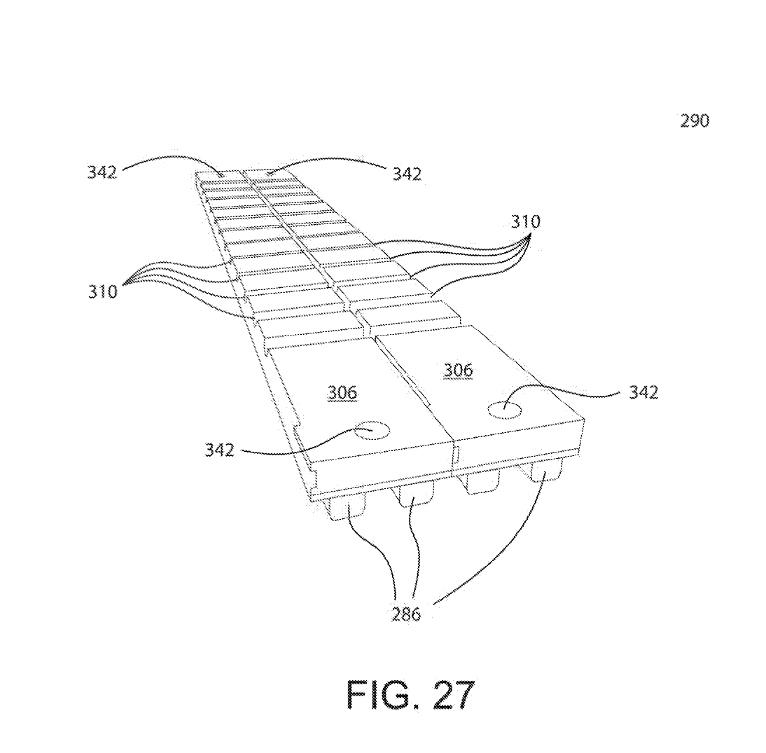

FIG. 27 is a top perspective view of two segments 306 of a bottom belt 290. In this view one can see the teeth 286 extending from the inner surface of the segments 306. The drive receptacles 342 are also visible. The channels 310 are visible. In one embodiment, there may be gaps or channels located at the segments of the top and bottom belts 322, 290 to allow for steam and heat to exit from the cooking volumes.

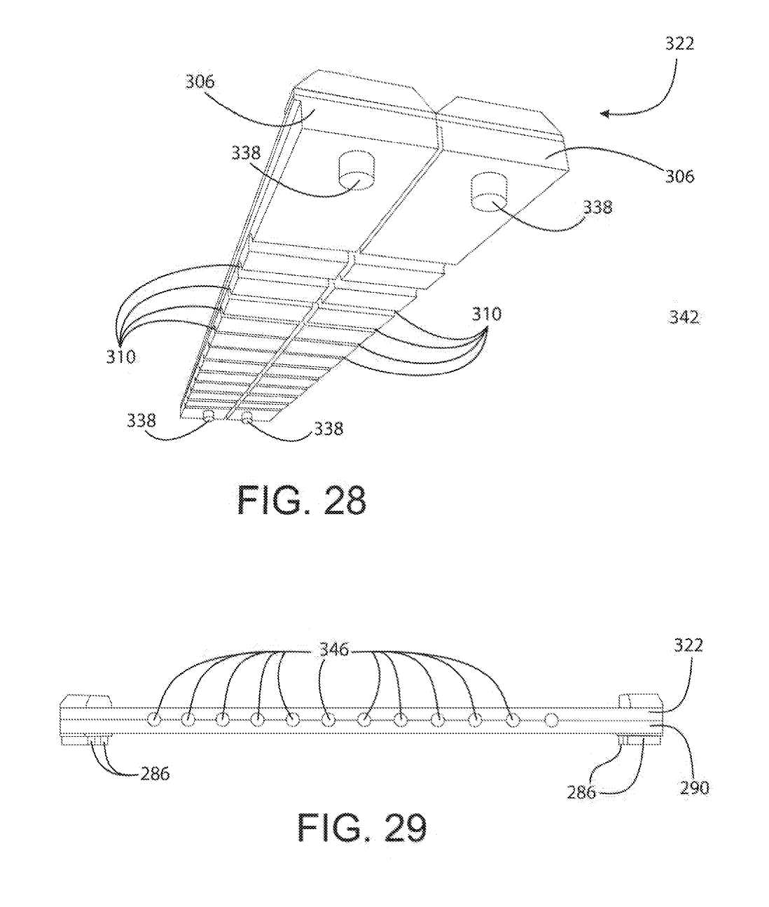

FIG. 28 is a bottom perspective view of two segments 306 of a top belt 322. In this view, one can see the drive teeth 338 extending each of the segments 306. In addition, the channels 310 are visible.

FIG. 29 shows a segment 306 of a top belt 322 meshed with a segment 306 of a bottom belt 290. Each adjacent pair of a channels 310 of the top belt 322 and bottom belt 290 have formed a cooking volume 346. Please note how the cross-sectional area of the cooking volume 346 is circular. One of ordinary skill in the art will recognize that by changing the shape of the channels 310, one can change the cross-sectional shape of the cooking volume, to include shapes such as, but not limited to: square, rectangular, oval, hexagonal, etc.

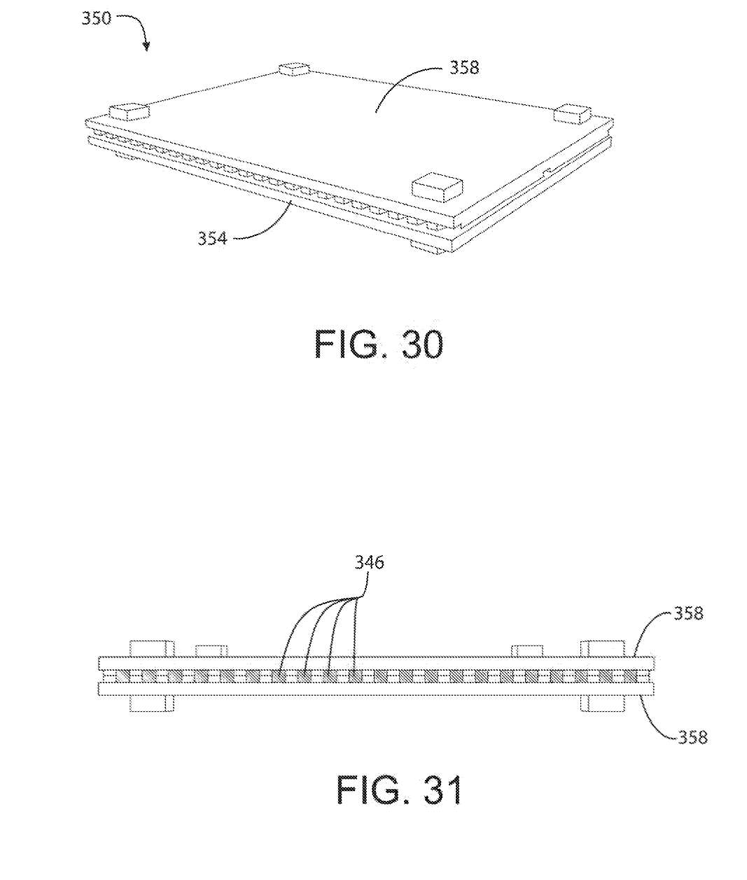

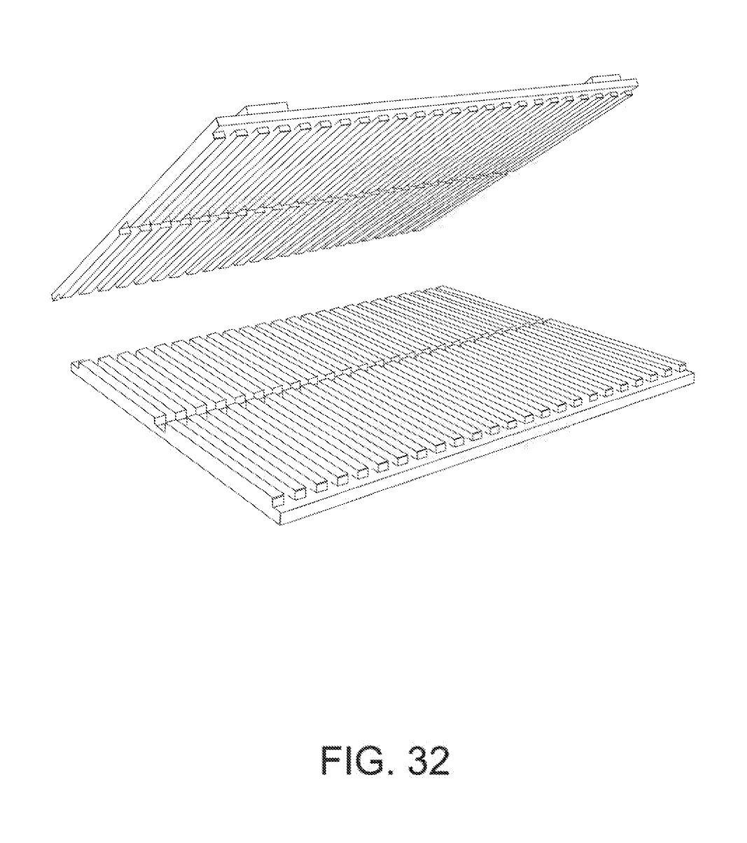

FIG. 30 shows a perspective view of two plates 350, 354 that may be used in a food cooking apparatus 350. The bottom plate 354 may be a fixed plate used in an apparatus similar to that in FIG. 11. The top plate 358 may be a plate that rotates relative to the bottom plate. FIG. 31 shows a side view of the two plates 350, 354, where the channels 310 in the top plate 358 and bottom plate 354 form a cooking volume 346. FIG. 32 shows the top plate 358 rotated up and away from the bottom plate 354. The channels 310 can be seen in the top and bottom plates 354, 358. There is also a steam exit channel 362 that runs transverse to the channel 310, which can allow steam to exit from the food being cooked.

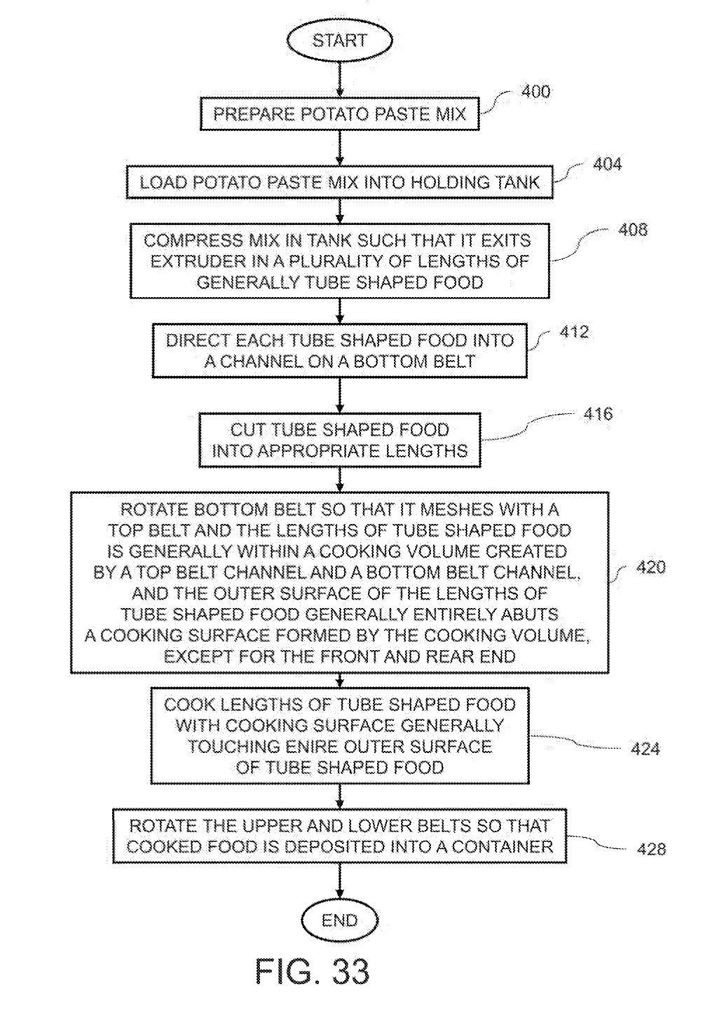

FIG. 33 shows a flow chart illustrating one disclosed method. At act 400, the user prepares a potato past mix. At act 404, the user loads the potato past mix into a holding tank of a food cooking apparatus. At act 408 the user, using a food cooking apparatus, compresses the mix in the tank such that it exits an extruder in a plurality of lengths of generally tube shape food. at act 412, the food cooking apparatus directs each length of tube shaped food into a channel on a bottom belt. At act 416, the food cooking apparatus, cuts each length of tube shaped food into appropriate lengths, generally at the exit end of the extruder. At act 420, the food cooking apparatus rotates the bottom belt so that it meshes with a top belt and the cut lengths of tube shaped food is generally enclosed within a cooking volume created by a top belt channel and a bottom belt channel, and the outer surface of the length of tube shaped food is generally entirely abutting a cooking surface formed by the cooking volume, except for the front and rear end of the length of tube shaped food. At act 424, the food cooking apparatus cooks the length of tube shaped food with the cooking surface generally touching the entire outer surface of the tube shaped food. At act 428, the food cooking apparatus rotates the upper and lower belts so that the cooked food is deposited into a container.

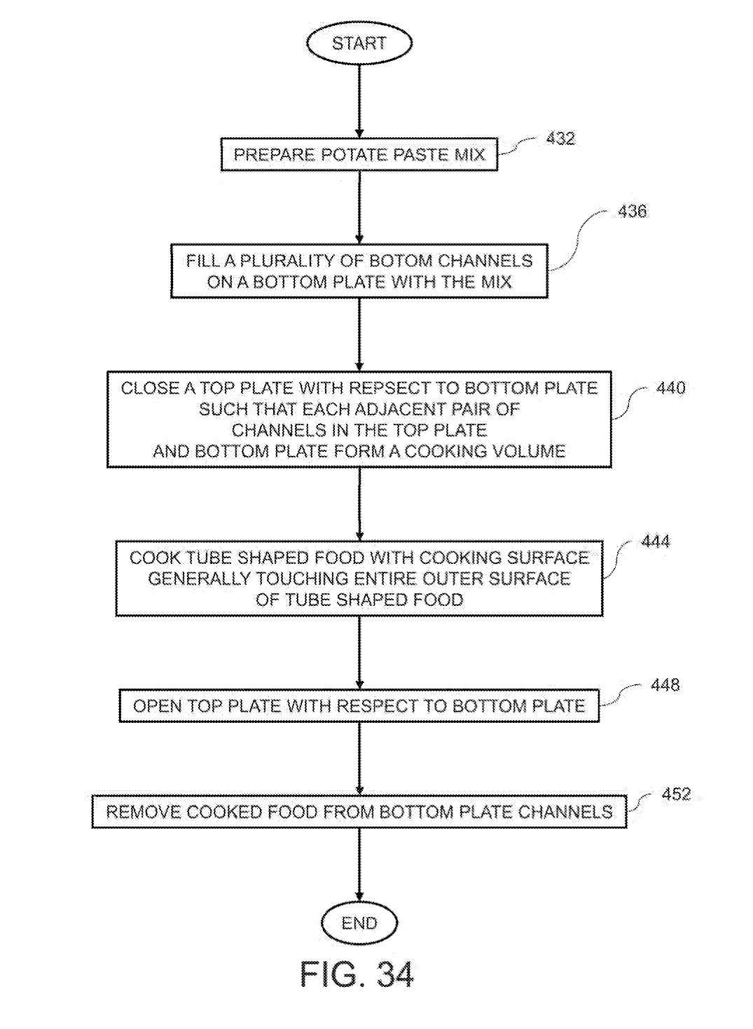

FIG. 34 shows a flow chart illustrating another embodiment of a disclosed method. At act 432, the user prepares a potato past mix. At act 436, the user fills a plurality of bottom channels on a bottom plate of a food cooking apparatus with the mix, forming generally tube shaped foods. In another embodiment, the user may manually extrude or purchases pre-formed mix and fills the plurality of bottom channels with the mix. At act 440 the user closes a top plate of a food cooking apparatus with respect to the bottom plate such that each adjacent pair of channels in the top plate and bottom plate form a cooking volume that generally encloses the tube shaped foods. At act 444, the food cooking apparatus cooks the tube shaped food with the cooking surface formed by the cooking volume generally touching the entire outer surface of the tube shaped food, except for a portion at the front and rear end of each tube. At act 448, the user opens the top late with respect to the bottom plate. At act 452, the user removes the cooked food from the bottom plate channels. The shape of the channels on these plates is not limited to only round shape, it can include any suitable shape including but not limited to square, oval, rectangular, triangle. Although FIGS. 33 and 34 discuss tube shaped foods, the foods do not have to be tube shaped, but rather may simply be lengths of food that are cook, and may have non-tube shapes.

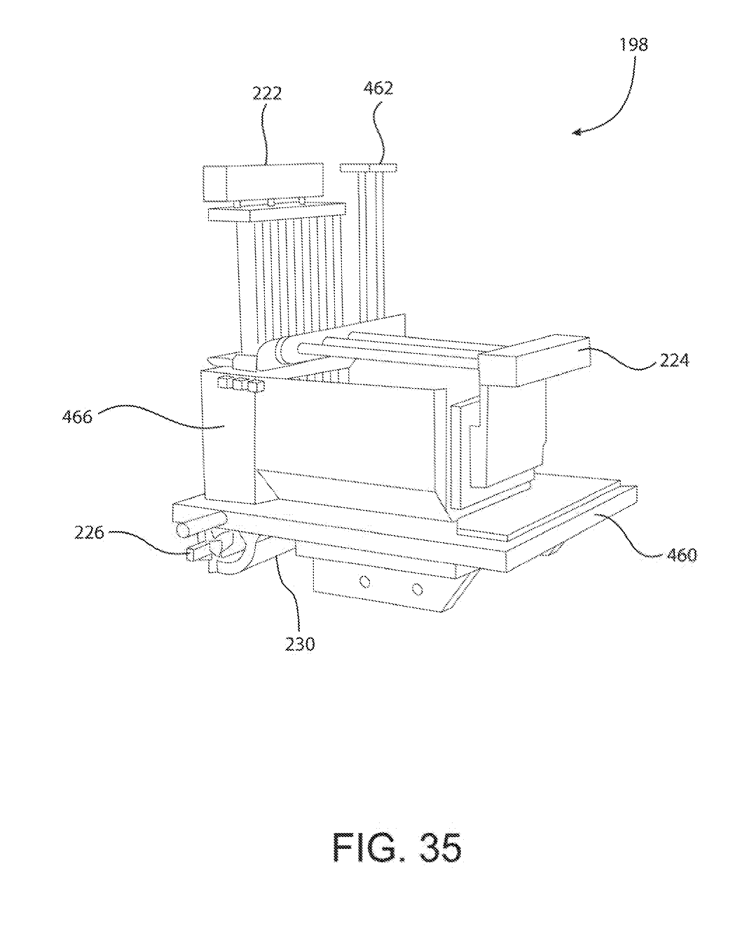

FIG. 35 is a perspective view showing generally the mechanisms in the interior of the holding tank 198. The relationship between the vertical pusher assembly 222, horizontal pusher assembly 224, cutting mechanism 226 and extruder 230 are generally shown. In addition the holding tank base 460 is shown. Also shown is a vertical cutter assembly 462. Also shown is removable mix holding container 466.

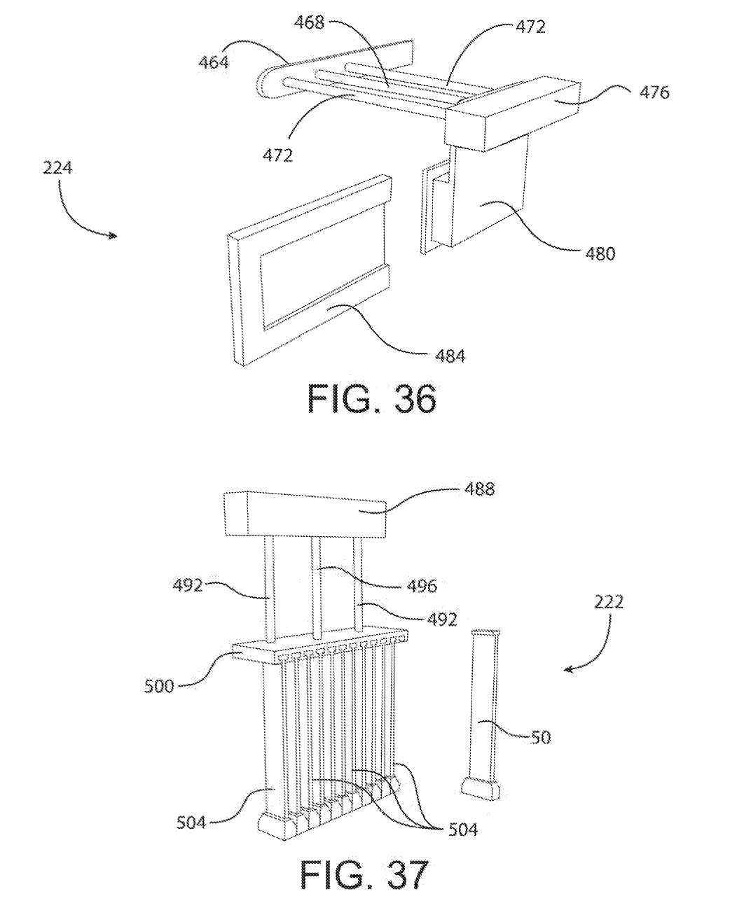

FIG. 36 shows details of the horizontal pusher assembly 224. The assembly 224 comprises a support bracket 464 which is attached to the interior of the holding tank 198, a threaded drive rod 468 attached to the bracket 464, and at least one guide rod 472 attached to the bracket. The drive system 476, attached to the interior of the holding tank 198, is in operable communication with the threaded drive rod 468. In operable communication with the threaded drive rod 468 is a pusher adapter 480, which is also in slideable communication with the guide rod 472. Attached to the adapter 480 is the pusher 484. In operation, the drive system 476 turns the threaded drive rod 468, which causes the pusher adapter 480 and pusher 484 to along the threaded rive rod 468 either towards the bracket 464 or away from the bracket 464.

FIG. 37 shows details of the vertical pusher assembly 222. The assembly 222 comprises a drive system 488 attached to the interior of the holding tank 198. Connected to the drive system is at least one guide rod 492. In operable communication to the drive system 488 is a threaded drive rod 496. An adapter 500 is in operable communication with the drive rod 496 and in slideable communication with the guide rod 492. Attached to the adapter 500 is a plurality of pushers 504. The number of pushers 504 is equal to the number of exit holes 298 on the extruder 230. One pusher 504 is shown disconnected from the adapter 500. In operation, the drive system 488 turns the threaded drive rod 496, which causes the adapter 500 and pushers 504 to move up and down along the threaded rive rod 496 either towards.

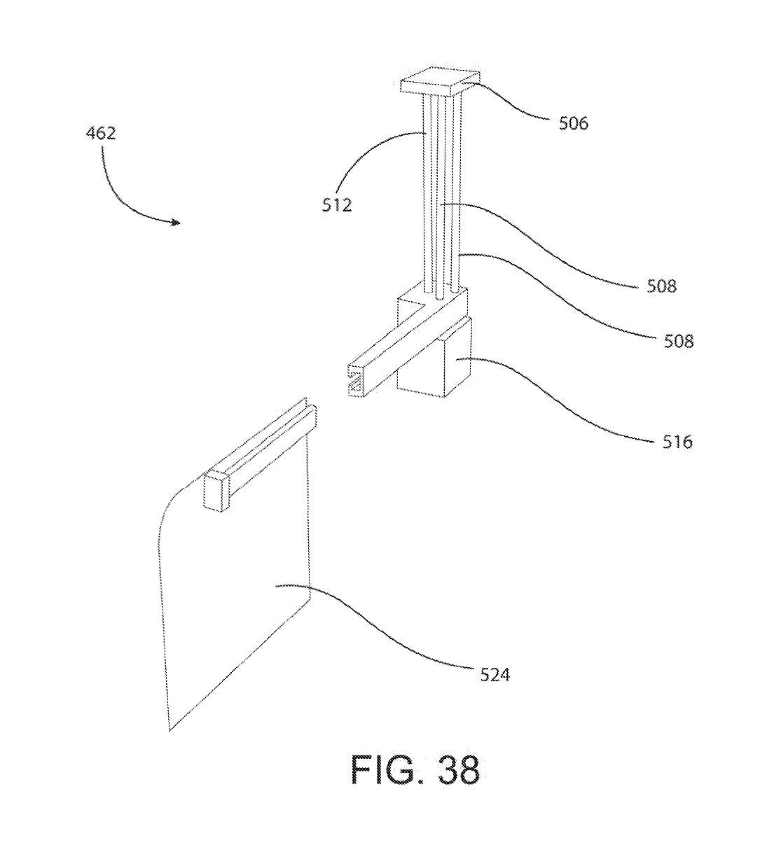

FIG. 38 shows details of the vertical cutter assembly 462. The assembly 462 comprises a support bracket 504 secured to the top of the holding tank 198. At least one guide rod 508 is attached to the bracket 504. A threaded drive rod 512 is in rotatable communication with the support bracket 504 is in operable communication with drive system 516. The drive system 516 is attached to the interior of the holding tank 198. An adapter 520 is in operable communication with the drive rod 512 and in slideable communication with the guide rod 508. Attached to the adapter 520 is the vertical cutter 524. In operation, the drive system 516 rotates the drive rod 512, causing the adapter 520 and vertical cutter 524 to move up or down along the drive rod 512.

FIG. 39 is a top perspective view of the removable mix holding container 466. At one end of the container 466 are a plurality of compartments 528 separated by dividers 532. A horizontal vertical cutter guide 536 traverses the two interior walls as shown. The number of compartments 528 is equal to the number of pushers 504, as well as to the number of exit holes 298 on the extruder 230. In operation, the vertical cutter 524 is lowered down so that it is adjacent to the compartments 528. Thus when the vertical pushers 504 are pushing the mix, the mix will not escape from being forced into the extruder entrance holes 294 due to the vertical cutter 524 and pushers 504 forcing the mix into the extruder entrance holes 294, and eventually out the extruder exit holes 298.

FIG. 40 shows a bottom view of the removable mix holding container 466. In this view you can see that the compartments 528 extend through the bottom 540 of the container 466. The extruder entrance holes 294 will be directly abutting where the compartments 528 go through the bottom 540.

French fries food is one of the world's most popular to enjoy. However, French fries are not the healthiest of food to consume because of the process which they are made by. French fries are made by being fried in hot oil. Even though in recent years most of the restaurants switched to a healthier oil, they are still not healthy to consume. Standard large order of fries in fast food restaurants contains around 500 calories of which around 200 are calories from fat. This invention changes the process for making a food equivalent to French fries significantly healthier. By changing the process, this food contains significantly fewer total calories and calories from fat when compared to fast food restaurants' French fries by volume and density. Because this process does not involve frying, the product produced has been given a new name; Mash Stix. The product's taste and texture is very much like that of French fries except Mash Stix are healthy.

One method for producing the mix is described below. Potatoes are boiled and mashed through a fine grinder to eliminate any granules. A small pre-determined amount of corn starch, vegetable oil and shelf-life preservatives are added and mixed thoroughly. Once all mixed, the mix is formed into predetermined block (size of holding tank of the invention machine). After formed the mixture may be refrigerated and delivered to restaurants to be used with the disclosed food cooking apparatus.

Some embodiments of the food cooking apparatus have the advantage of being able to do multiple tasks. Once loaded with the mix, the machine may be fully automated. It pushes the mix and extrudes it through multiple pushers and an extruder. Right at the end of the extruder, there is a vertical cutter which is driven by a small motor which allows it to move up and down to perform the cutting operation. Immediately below the extruder is the bottom belt with channels which are generally aligned with the exit extruder holes. Upon exit from the extruder, the mix transitions directly to the belt's channels. The bottom belt is driven by a motor that has a gear with chain or belt which drives a bigger gear. The bigger gear has an adapter in its center which the bottom belt frame's shaft connects to. This extra connection allows for an easy maintenance of the belts. The bottom belt frame's shaft has two gears, one on each width end of the actual belt for uniform pull. The two gears pull and thus rotate the belt by engaging with the interior side of the belt. The shaft is strategically positioned near the exit shoot to make sure the belt always has tension in the section that carries the mix. The belt itself is guided by rows of freely spinning small guide wheels which allow for smooth movement. In another embodiment, the guide wheels may be slightly impeded by friction thus allowing giving the drive system better control over the whole movement. Those small wheels also serve another critical task. They make sure that the belt track is always exactly positioned to allow for extruded mix to perfectly transition onto the belt. Each end of the belt's segment has a vertical small round hole on the cooking surface which allows the top belt segments to engage and in return move the top belt along with the bottom belt. The top belt's segments have small pins or drive teeth sticking out which stick out just enough to engage with the bottom belt's segments at the drive receptacles.

In one embodiment, each belt frame has its own heater. The bottom belt frame has a heater facing upwards. It is located near the top of the belt's frame right below the belt that moves the mix. Top belt frame has a heater facing downward. It is located near the bottom of the belt's frame right above the belt that moves the mix. Each of the heaters are easily replaceable if need to be serviced. Each one is mounted in a heater frame which is secured to the belt's frame. Guides inside the heater frame allow for easy removal of the heater. With the power connectors positioned in the back of the heaters, once fully engaged in the frame, each heater connects to its own source of power which is located in the back. Those connections are fixed in place in a way that allows for an easy connection without any deflection in the structure.

To the left side before the finished food holding tank is an exit shoot. Finished baked mix slides down the bottom belt and out the exit shoot. The exit shoot's top edge is positioned slightly lower than the meeting height of the belt to make sure the baked mix smoothly transitions onto the exit shoot. The horizontal distance between the top edge of the exit shoot and the belt is very small to prevent any baked mix from falling down internally instead of onto the exit shoot. From the exit shoot the food falls into the finished food holding tank and it's ready to be scooped up into the food container and be served to the customer.

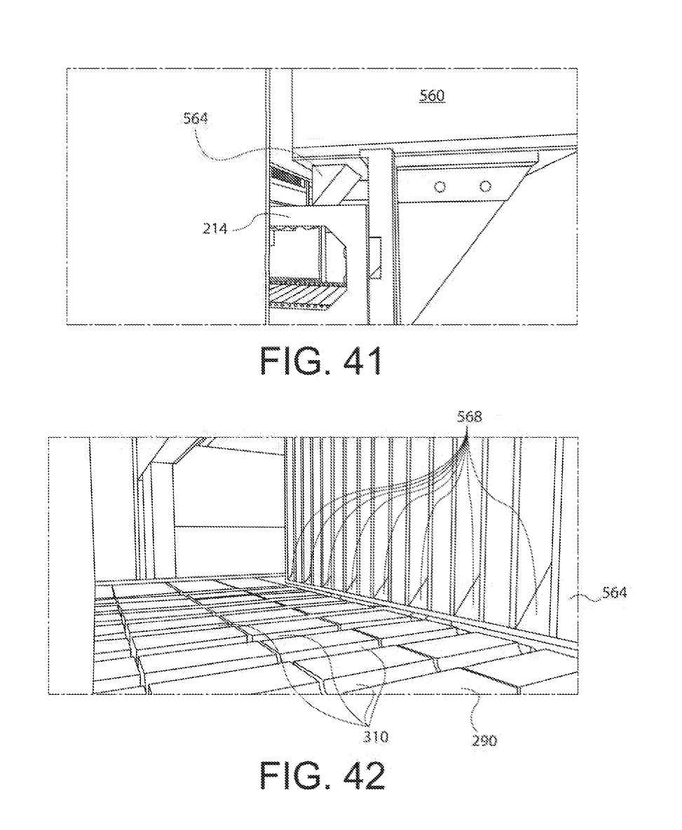

In another embodiment, the disclosed food cooking apparatus may be configured to use frozen sticks of the potato paste mix. Thus, the frozen sticks will be placed on the channels 130 of the apparatus and cooked much like the potato paste mix. In the new embodiment, a portion of which is shown in FIG. 41, a holding tank 560 is in communication with an angled slide 564 in communication with the channels 310 in the bottom belt 290. The angled slide 564, as shown in FIG. 42, has a plurality of angled grooves 568 that line up with the plurality of channels 310 in the bottom belt 290. In one simple embodiment, the holding tank 560 will act as a hopper for the frozen sticks. A user can simply fill the tank 560 with loose frozen sticks, and shake the tank 560 to dispense the sticks through the angled slide and onto the channels 310.

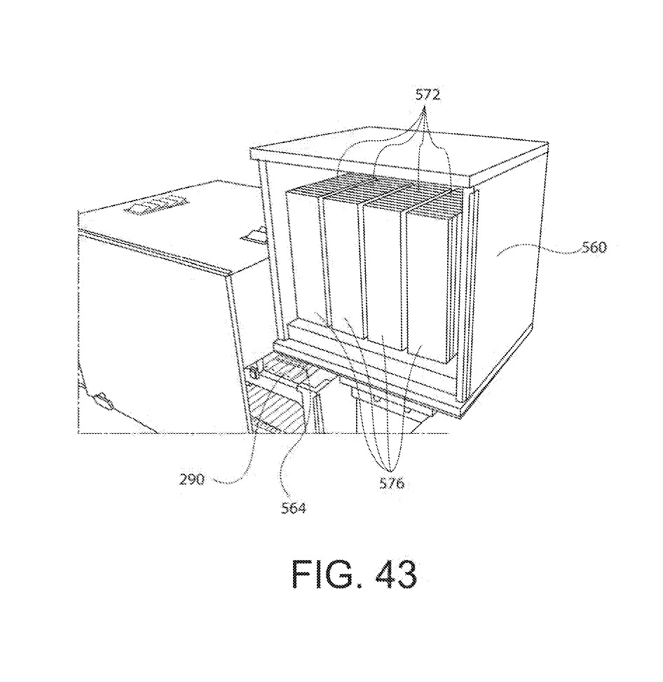

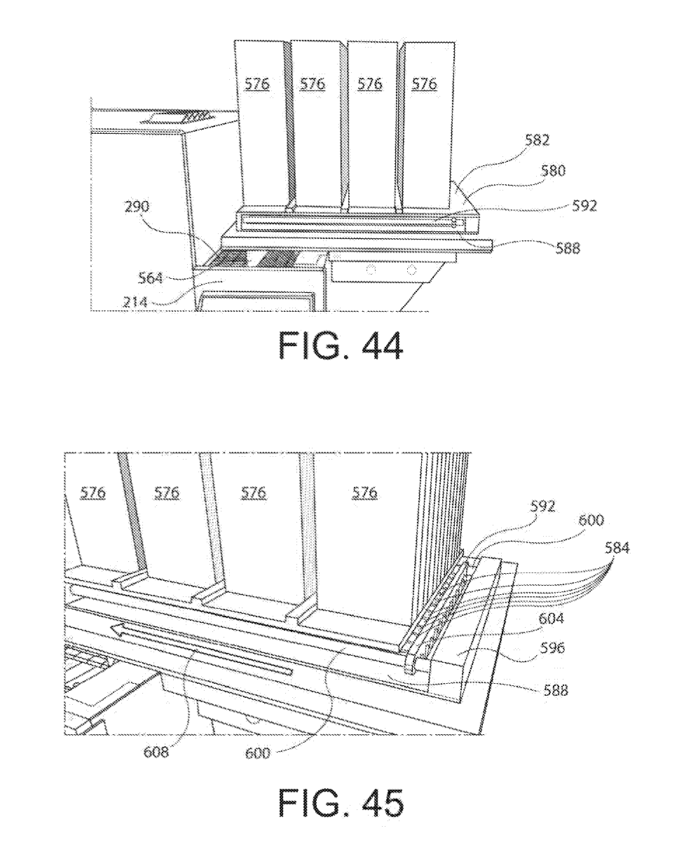

FIG. 43 shows a view of the holding tank 560 with one wall removed. Inside the tank 560, one can see containers 576 of the frozen sticks 572. Each container 576 may comprise internal walls 612 (clearly visible in FIG. 47) that separate each column of frozen sticks stacked inside the container 576. And each container may have a hole or opening in the bottom of the container. The frozen sticks 572 may be released through the holes or openings in the bottom the containers as needed for production. FIG. 44 shows a side view of the tank 560 with all the walls of the tank 560 removed. The containers 576 sit on an upper surface 582 of a pedestal 580. The pedestal has a hole beneath each container 560 to allow the frozen sticks 572 to fall out of the container 576 due generally to gravity and fall onto pedestal channels 584 located in the bottom 588 of the pedestal 580. A pusher mechanism 592 is configured to push the frozen sticks 572 along the pedestal channels 584 until they enter the angled slide 564.

FIG. 45 is a close up view of the pedestal 580 with a portion of the pedestal 580 cutaway to show more details of the pusher mechanism 592 and pedestal channels 584. The pusher mechanism 592 comprises a motor housing 596, rotatable threaded shafts 600 and a pusher 604. The motor in the motor housing 596 rotates the shafts 600, the pusher 604 is attached to the shafts 600 via threaded holes in the pusher. As the shafts 600 rotate, the pusher will move in the direction of the arrow 608, when the shafts are rotated in the opposite direction, the pusher will move in a direction opposite to the arrow 608. The pusher 604, when moving in the direction of the arrow 608, will push the frozen sticks 572 along the channels 584 and into the angled slide 564.

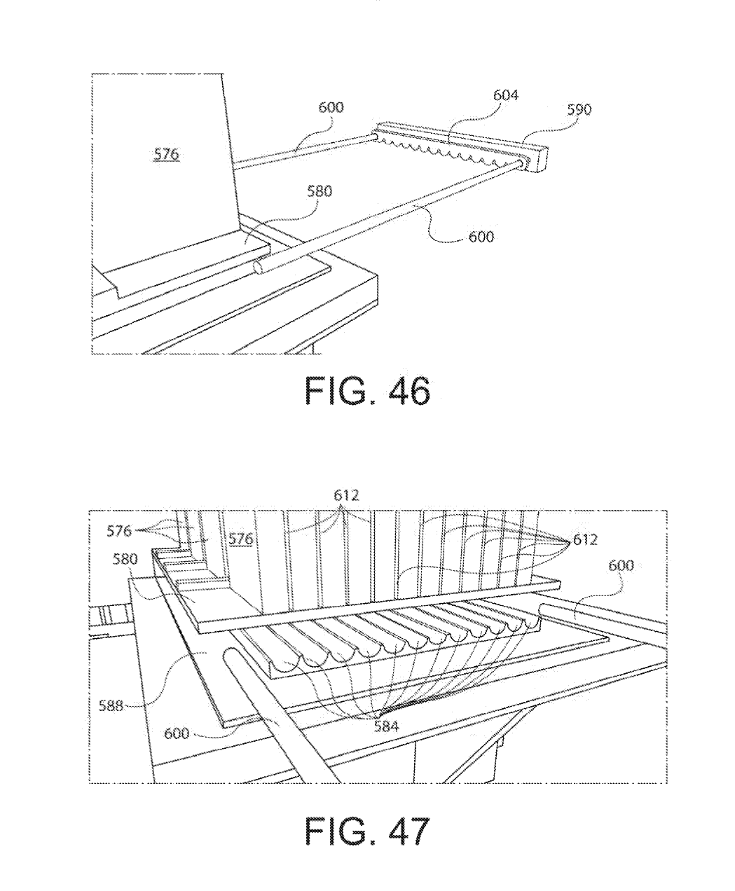

FIG. 46 shows detailed view of the pusher mechanism 592 separated from the pedestal 580.

FIG. 47 shows a close up view of the pedestal channels 584 with the pusher mechanism 592 separated from the pedestal 580. The pusher mechanism may be in electrical communication with a CPU that controls when and how quickly the pusher pushes the frozen sticks into the angled slider.

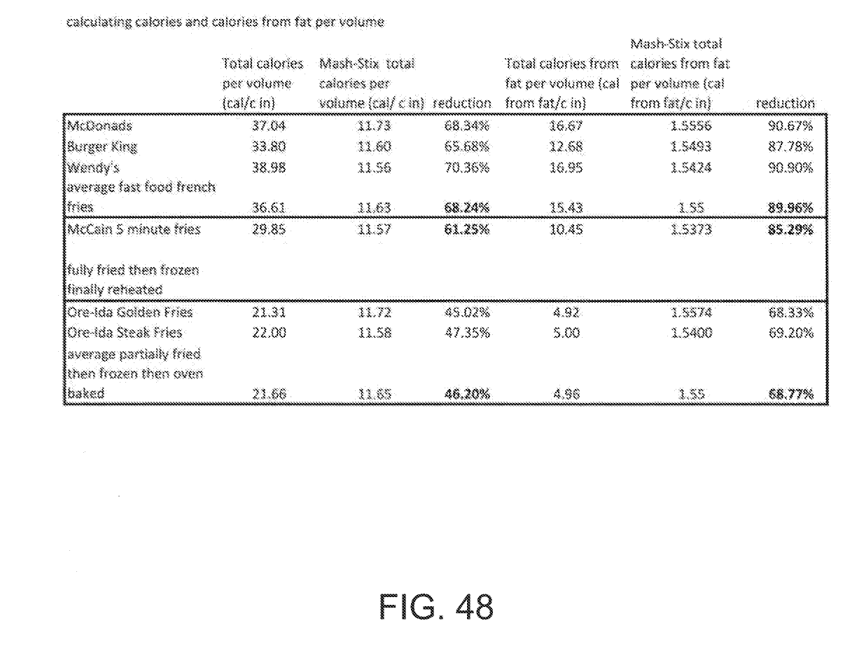

FIG. 48 shows a chart of calorie comparisons. The first column shows other potato food manufacturers, including McDonalds, Burger King, McCain, Ore-Ida etc. The second column shows the total calories per volume of those potato foods from other manufacturers. The third column shows the calories per volume of the instant food cooking apparatus and method (called “mash-stix”). The fourth column shows the reduction in calories per volume of the mash-stix food compared to the other potato foods. The fifth column shows the total calories from fat per volume, and the sixth column shows the total calories from fat for the mash-stix food, and the seventh column shows the reduction of calories of the mash-stix food. The reduction of calories per volume of the mash-stix food ranges from about 45% to about 70%. The reduction of calories from fat per volume ranges from about 68% to about 91%. These reductions are very attractive to consumers and manufacturers in today's health conscious society. The reduction of calories is specific to the exact recipe used, and different recipes may lead to different caloric content.

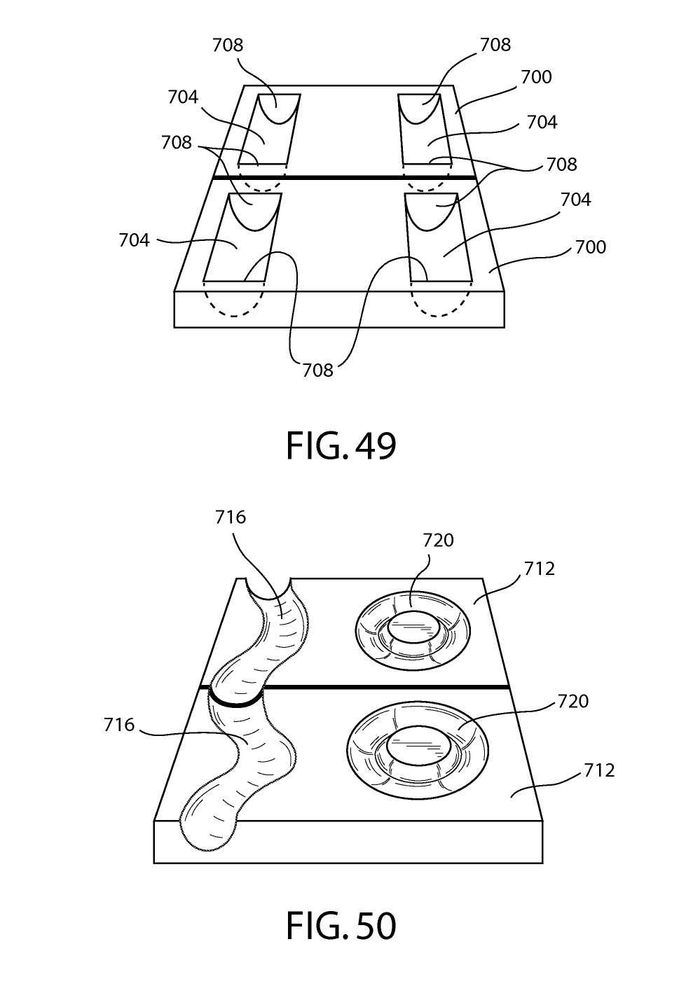

FIG. 49 shows another embodiment of bottom belt segments 700. In this view, only a portion of two bottom belt segments 700 are shown. In this embodiment, the channels are no longer continuous on the belt, as shown in FIG. 26 for example, but rather, each segment may comprise several discrete cooking volumes 704. The discrete cooking volumes 704 may be created by endwalls 708. In one embodiment the top belt segment will also have matching discrete cooking volumes, such that when the top belt and bottom belt mesh together as discussed previously, the discrete cooking volumes will come together and form a generally closed cooking volume, with a top cooking surface and a bottom cooking surface.

FIG. 50 shows another embodiment of the bottom belt segments 712. In this embodiment, one channel may comprise a zig-zag shaped continuous channel 716. Of course, one of ordinary skill will recognize that the continuous channel 716 may be modified to have end walls such as discussed in FIG. 49, such that the channel 716 form discrete cooking volumes. In addition, the bottom belt segments 712 also have generally torus shaped channels 720. The top belt segments (not shown) may have matching channels, such that when the top belt and bottom belt mesh together, the zig-zag shaped channels will form a cooking volume with a top cooking surface and a bottom cooking surface in a generally zig-zag shape. Similarly, the top belt segments (not shown) may have matching torus shaped channels, such that when the top belt and bottom belt mesh together, the torus shaped channels will form a generally torus shaped cooking volume with a top cooking surface and a bottom cooking surface. One of ordinary skill in the art will recognize a variety of shapes of channels and cooking volumes may be formed on the top belt and bottom belt, including but not limited to rings, small balls, ovals, small disk like shapes, egg shapes, squares, rectangular shapes, and other shapes that may be easy to form and to enclose.

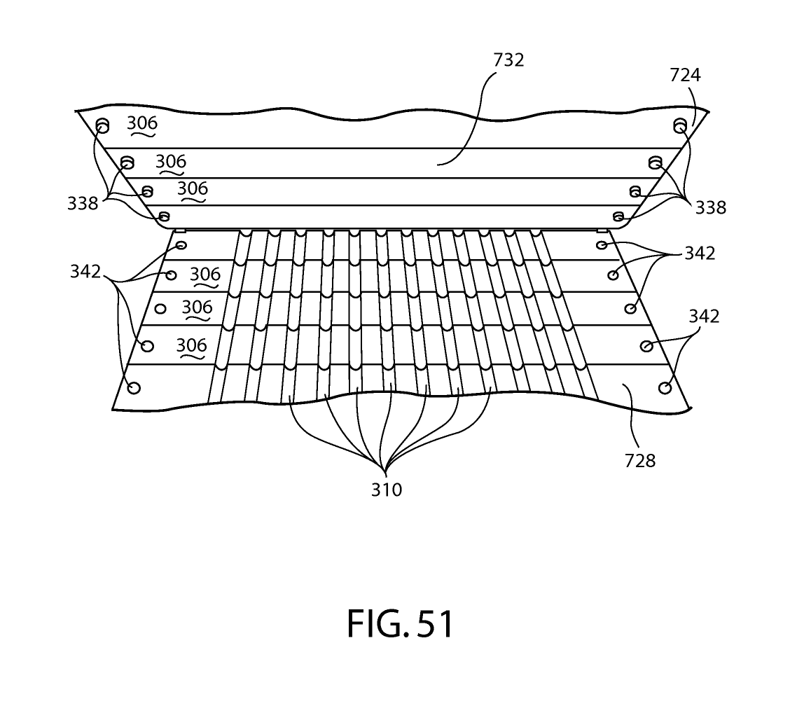

FIG. 51 shows another embodiment of the top belt 724 and bottom belt 728. In this embodiment, the bottom belt has channels 310. However, top belt 724 does not have any channels, rather it simply comprises segments 306 and forms a generally flat cooking surface. Thus when the top belt 724 and bottom belt 728 mesh, the food mix is contained in the bottom channels 310, and is cooked by the channel surface on the bottom belt 728 and the cooking surface 732 of the top belt 724. This invention has the advantage of lowering the cost of manufacture of the food cooking apparatus since the top belt 724 does not have to be as accurately aligned with the bottom belt 728, and the flat surface comprising the bottom belt 728 should be less expensive to manufacture than the bottom belt 728 with its multiple channels 310.

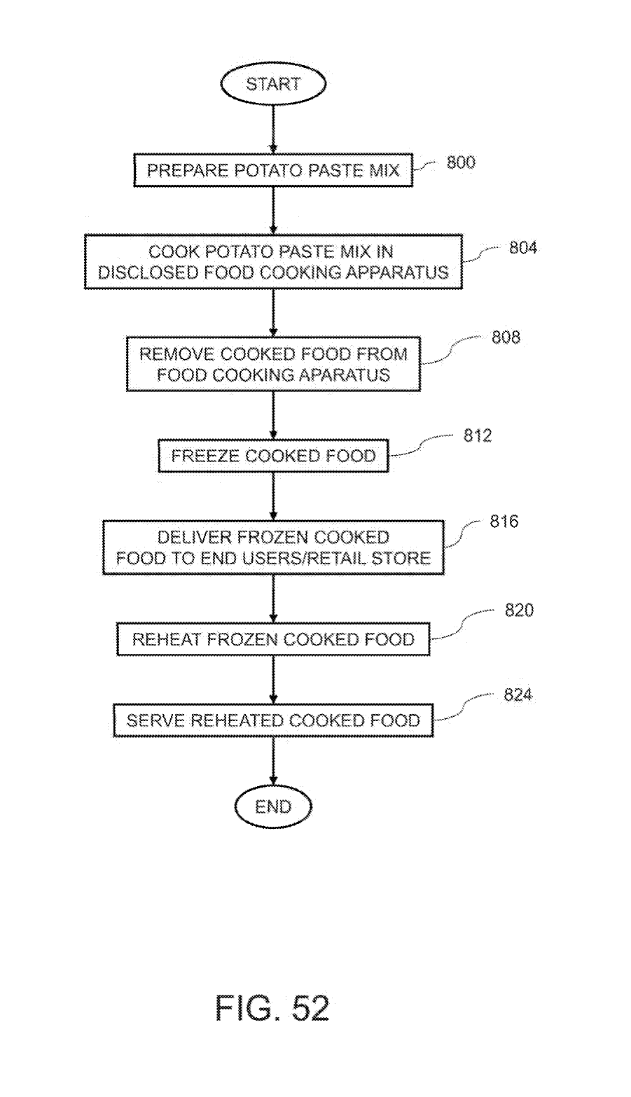

FIG. 52 shows another embodiment of the disclosed method. At act 800, the potato past mix is prepared. At act 804 the potato past mix is cooked in any of the disclosed food cooking apparatuses. At act 808, the cooked food is removed from the food cooking apparatus, and frozen at act 812. At act 816, the frozen cooked food is delivered to end users, or may be delivered to retail stores, where consumers may buy. Once the end user or consumer obtains the frozen cooked food, he may reheat the frozen cooked food at act 820. The food may be reheated in a conventional oven, microwave oven, or any other suitable reheating method, including but not limited to heat lamps. At act 824, the reheated cooked food may be served and eaten.

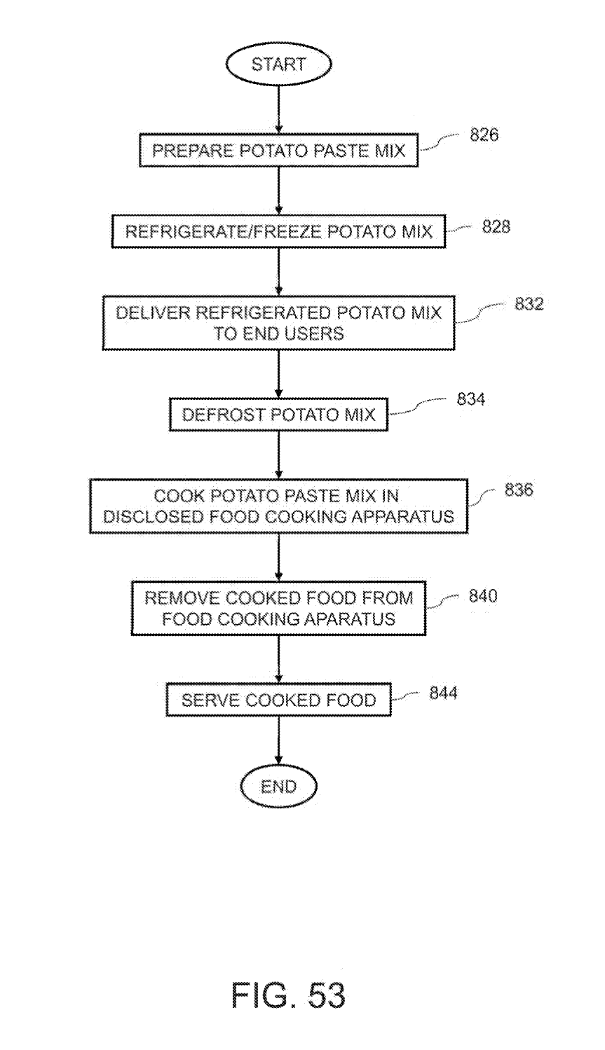

FIG. 53 shows another embodiment of the disclosed method. At act 826, the potato past mix is prepared. At act 828 the potato mix is refrigerated or frozen. At act 832 the refrigerated or frozen potato mix is delivered to end users either directly to restaurants, or retail stores. At act 834, the potato paste mix may be defrosted (if it was frozen). At act 836, the potato mix is cooked in any of the disclosed food cooking apparatuses. At act 840 the cooked food is removed from the cooking apparatus. At act 844, the food is served and eaten.

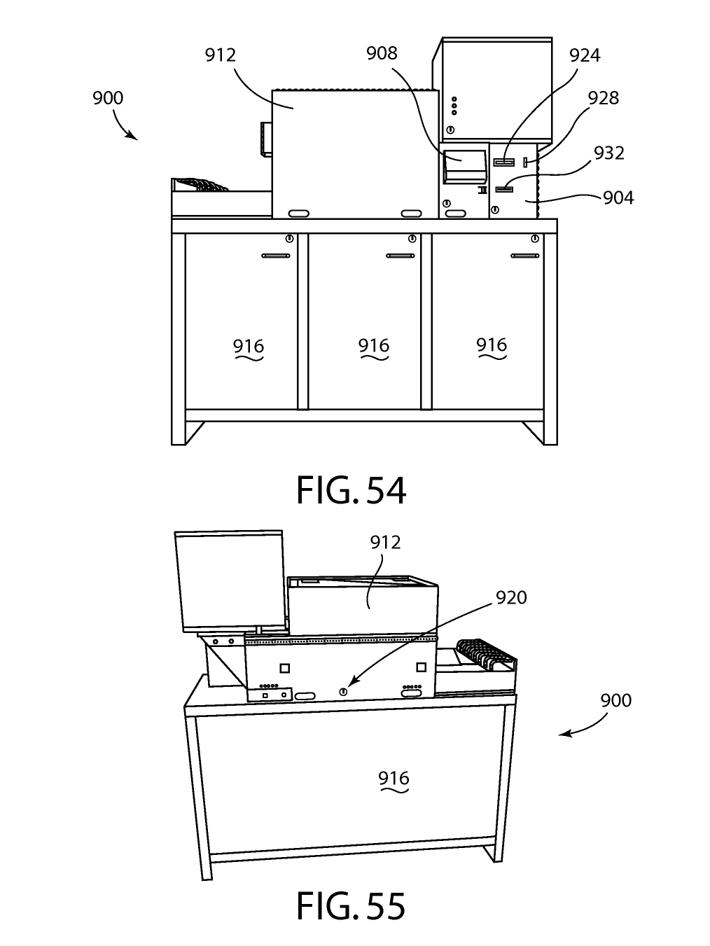

FIG. 54 is a front view of a disclosed vending machine version of the disclosed food cooking apparatus 900. The disclosed food cooking apparatus may be in operational communication with a payment accepting mechanism. In one embodiment the payment accepting mechanism 904 may be secured to the food cooking apparatus and upon sufficient insertion of the funds; a consumer can select from the existing touch screen display 908 the product he or she may desire. The payment accepting mechanism 904 may have a slot 924 for cash, a slot for coins 928, and slot for cards 932. Upon selection of the desired product, the payment accepting mechanism will return any unused funds. The payment accepting mechanism may take paper money, coins, credit and debit cards, or any other suitable payment means. At the same time that the transaction is complete, the food cooking portion 912 of the device 900 will begin the process of making the selected item by the consumer. From the touch screen display 908, the consumer may be able to select from multiple options: desired flavor, color and crispiness. Crispiness may be adjusted by many means including but not limited to: increasing the temperature or slowing the speed of the belts. In one embodiment, the enclosures surrounding the machine 900 may provide for a relatively low height of the device 900, and thus there may be no need for a full upright vending style set-up enclosure, however, in another embodiment there may be a full upright vending style set-up enclosure for the device 900. In the shown embodiment, the device 900 may have lockable cabinets 916 below the food cooking portion 912. The cabinets 916 may be used to store supplies for a quick and efficient replenishment. To prevent theft, all the access panels may have locks 920. FIG. 55 is a rear view of the disclosed vending machine version of the disclosed food cooking apparatus 900.

In one embodiment, the disclosed device may be used as follows. The owner of the device 900 readies the machine, he may assure the mix holding tank is full, check that the payment accepting mechanism is ready to accept more money, the paper container holder is re-stocked, the scoop which the consumer will use to put the finished cooked potato product from the holding tray to the paper container from which the consumer will eat the cooked potato product out of. The consumer may insert payment into the payment accepting mechanism. The consumer may then select the from the touch screen display the desired product. If the payment inserted is sufficient, the food cooking process begins. If the payment is insufficient, the consumer is alerted and is asked to insert the correct payment amount. If there are remaining funds after the selection is made then the remaining funds given back to the consumer. If a credit card is used, then the charge to the credit card will equal to the amount that the selected item was. Upon completion of the cooking process, the consumer uses the provided scoop and loads the food product that is in the holding tray into a paper container that in a dispenser right above the exit shoot. The electronic display 908 may be connected to a CPU. The CPU may keep track of the inventory levels in order to alert others when the machine is running low of mix, or other supplies. In case supplies are depleted, the machine 900 may turn itself off and will indicate that it is out of service. An alert may be sent to the owner to replenish the item that is missing. Some changes made to the embodiments of the disclosed food cooking apparatus include: payment collecting mechanism has been added to the apparatus. The money accepting mechanism is electronically connected to the touch screen display as well as the main electronics system in the previously disclosed embodiments. The feet from the previous embodiments may be removed and instead the machine is now secured to the newly added cabinet. The cabinet may be used for storage of items that need replenishment: potato food mix, and paper containers for finished product. The cabinets may have the ability to serve as freezers or refrigerators to be able to properly store the potato food mix. The access panels may have locks installed.

This invention has many advantages. Through this invention, total calories and calories from fat are significantly reduced with respect to French fry type of food. By eliminating the frying process, the food has a lighter density because it does not have any oil to absorb. Density is further reduced because of the steam that is generated during the cooking process. Only a small amount of moisture is released during the cooking process to ensure that the finished product is not dry. Currently there is no other invention available to produce such a food product that when fully cooked, has texture, taste and crispiness of a French fries. The reduced calorie food produced by the disclosed food cooking apparatus gets a French fry-like texture through contact with the cooking surface of the cooking volume formed by the belts. In one embodiment, the food cooking apparatus is generally automatic, all the user is required is load the mix in the holding tank, and the cooked food comes out of the apparatus. As such, this food cooking apparatus is optimal for restaurants and fast food establishments where high rate production is required. Frozen sticks may be used, either with a hopper type set up that shakes the sticks onto the bottom belt channels 130 or through an automated pusher mechanism.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A food product comprising:
a potato mixture that is cooked without frying;
wherein the food product has the appearance, taste and texture similar to a French fry cooked in oil; and
wherein the food product has less than 20 calories per cubic inch.

2. The food product of claim 1, wherein the food product has less than 4 calories from fat per cubic inch.

3. A food cooking apparatus comprising:
a housing;
a holding tank attached to the housing;
an extruder in fluid communication with the holding tank;
a bottom continuous belt generally adjacent to the extruder, the bottom continuous belt comprising a plurality of bottom channels on the outer surface of the belt;
a top continuous belt, that meshes with the bottom continuous belt along a belt mesh length, the top continuous belt comprising a generally flat surface on the outer surface of the belt such that at the belt mesh length, the generally flat surface and each bottom channel form a cooking volume, where the cooking volume has a cooking surface that is configured to generally completely abut the outer surface of a food located in the cooking volume;
a bottom heater attached to the housing and configured to heat the bottom continuous belt at the belt mesh length in order to cook the food within the cooking volume;
a top heater attached to the housing and configured to heat the top continuous belt at the belt mesh length in order to cook the food within the cooking volume;
a food holding container attached to the housing, and adjacent to the end of the bottom continuous belt opposite the extruder end of the belt; and
wherein the food cooking apparatus is configured to rotate the top continuous belt and bottom continuous belt such that any food deposited from the extruder onto the bottom channels tend to move towards the belt mesh length and into the cooking volume then out into the finished food holding container, and that the top and bottom heaters heat the belt mesh length and the food remains in the cooking volume for such time that the food is suitably cooked when it leaves the bottom continuous belt and enters the finished food holding container.

4. The food cooking apparatus of claim 3, further comprising:
at least one pair of endwalls located in at least one bottom channel, the pair of endwalls creating at least one discrete cooking volume in the channel.

5. The food cooking apparatus of claim 3, where the channels have a zig-zag shape.

6. The food cooking apparatus of claim 3, where the channels have a generally sinusoidal shape.

7. The food cooking apparatus of claim 3, where the channels have a generally toroidal shape.

8. The food cooking apparatus of claim 3, where the channels have a generally circular shape.

9. A food cooking apparatus comprising:
a housing;
a holding tank attached to the housing;
an extruder in fluid communication with the holding tank;
a bottom continuous belt generally adjacent to the extruder, the bottom continuous belt comprising a plurality of bottom channels on the outer surface of the belt;
at least one pair of bottom endwalls located in at least one bottom channel, the pair of bottom endwalls creating at least one discrete bottom cooking volume in the channel;
a top continuous belt, that meshes with the bottom continuous belt along a belt mesh length, the top continuous belt comprising a plurality of top channels on the outer surface of the belt;
at least one pair of top endwalls located in at least one top channel, the pair of top endwalls creating at least one discrete top cooking volume in the channel;
a belt mesh length, formed by the meshing of the bottom and top continuous belt, such that each pair of adjacent top and bottom channels form a cooking volume, and where each discrete bottom cooking volume and discrete top cooking volume mesh together to form a generally closed cooking volume, where the cooking volume has a cooking surface that is configured to generally completely abut the outer surface of a food located in the cooking volume;
a bottom heater attached to the housing and configured to heat the bottom continuous belt at the belt mesh length in order to cook the food within the cooking volume;
a top heater attached to the housing and configured to heat the top continuous belt at the belt mesh length in order to cook the food within the cooking volume;
a food holding container attached to the housing, and adjacent to the end of the bottom continuous belt opposite the extruder end of the belt; and
wherein the food cooking apparatus is configured to rotate the top continuous belt and bottom continuous belt such that any food deposited from the extruder onto the bottom channels tend to move towards the belt mesh length and into the cooking volume then out into the finished food holding container, and that the top and bottom heaters heat the belt mesh length and the food remains in the cooking volume for such time that the food is suitably cooked when it leaves the bottom continuous belt and enters the finished food holding container.

10. The food cooking apparatus of claim 9, where the bottom and top channels have a zig-zag shape.

11. The food cooking apparatus of claim 9, where the bottom and top channels have a generally sinusoidal shape.

12. The food cooking apparatus of claim 9, where the bottom and top channels have a generally toroidal shape.

13. The food cooking apparatus of claim 9, where the bottom and top channels have a generally circular shape.

14. A method of cooking food, the method comprising:
preparing a potato paste mix;
placing a length of the mix into respective bottom channels of a cooking surface; enclosing the length of mix in a cooking volume, such that an outer surface of the length of mix is generally entirely abutting a cooking surface formed by the cooking volume;
cooking the length of mix with the cooking surface generally touching the entire outer surface of the length of mix;
removing the cooked lengths of mix from the cooking surface;
freezing the cooked lengths of mix;
delivering the cooked lengths of mix to retail stores or end users;
reheating the cooked lengths of mix;
serving the cooked lengths of mix.

15. A method of cooking food, the method comprising:
preparing a potato paste mix;
refrigerating or freezing the potato paste mix;
delivering the potato paste mix to retail stores or end users;
placing a length of the mix into respective bottom channels of a cooking surface;
enclosing the length of mix in a cooking volume, such that an outer surface of the length of mix is generally entirely abutting a cooking surface formed by the cooking volume;
cooking the length of mix with the cooking surface generally touching the entire outer surface of the length of mix;
removing the cooked lengths of mix from the cooking surface;
serving the cooked lengths of mix.

16. The method of cooking food of claim 15, further comprising:
defrosting the potato mix.

17. A vending machine style food cooking apparatus comprising:
a housing;
a holding tank attached to the housing;
an extruder in fluid communication with the holding tank;
a bottom continuous belt generally adjacent to the extruder, the bottom continuous belt comprising a plurality of bottom channels on the outer surface of the belt;
a top continuous belt, that meshes with the bottom continuous belt along a belt mesh length, the top continuous belt comprising a plurality of top channels on the outer surface of the belt such that at the belt mesh length, each pair of adjacent top and bottom channels form a cooking volume, where the cooking volume has a cooking surface that is configured to generally completely abut the outer surface of a food located in the cooking volume;
a bottom heater attached to the housing and configured to heat the bottom continuous belt at the belt mesh length in order to cook the food within the cooking volume;
a top heater attached to the housing and configured to heat the top continuous belt at the belt mesh length in order to cook the food within the cooking volume;
a food holding container attached to the housing, and adjacent to the end of the bottom continuous belt opposite the extruder end of the belt;
an electronic display located on the housing;
a payment accepting mechanism located on the housing;
a CPU located within the housing and in signal communication with electronic display and payment accepting mechanism;
wherein the food cooking apparatus is configured, upon proper payment made at the payment accepting mechanism, to rotate the top continuous belt and bottom continuous belt such that any food deposited from the extruder onto the bottom channels tend to move towards the belt mesh length and into the cooking volume then out into the finished food holding container, and that the top and bottom heaters heat the belt mesh length and the food remains in the cooking volume for such time that the food is suitably cooked when it leaves the bottom continuous belt and enters the finished food holding container.

18. The vending machine style food cooking apparatus of claim 17 further comprising:
at least one cabinet located below the housing.

19. The vending machine style food cooking apparatus of claim 18 wherein the at least one cabinet is refrigerated.
